(19) United States
(12) Patent Application Publication
(10) Pub. No.: US 2020/0096786 A1
(43) Pub. Date: Mar. 26, 2020

(54) EYE GESTURE DETECTION AND CONTROL METHOD AND SYSTEM

(71) Applicant: Johnson & Johnson Vision Care, Inc., Jacksonville, FL (US)

(72) Inventors: Adam Toner, Jacksonville, FL (US); Scott K. Humphreys, Greensboro, NC (US); Donald K Whitney, Melbourne, FL (US)

(21) Appl. No.: 16/138,438

(22) Filed: Sep. 21, 2018

(51) Int. Cl. G02C 7/04; G06F 3/01; G02C 11/00; G01P 15/18

(52) U.S. Cl. CPC G02C 7/041; G06F 3/017; G01P 15/18; G02C 11/10; G06F 3/013

(57) ABSTRACT

Methods and systems for gesture recognition in an ophthalmic device are described. An example method may comprise receiving, by a first sensor system disposed on or in a first ophthalmic device, first sensor data representing a first movement of a user; determining, based on at least the first sensor data, that the first movement is indicative of a gesture mode trigger; causing, based on the gesture mode trigger, the first sensor system to enter a gesture mode; receiving, during the gesture mode, second sensor data; determining, based on the second sensor data, a second movement, wherein the second movement represents a change relative to one or more of a first axis and a second axis; determining a gesture of the user by comparing the second movement to one or more stored movements associated with corresponding gestures; and processing the gesture of the user.

### BACKGROUND

The present methods and systems relate to ophthalmic devices having embedded controlling elements, and more specifically, to use the embedded controlling elements to conduct pairing, calibration, customization sequences, gesture recognition, and other operations based upon user actions.

Near and far vision needs exist for all. In young non-presbyopic patients, the normal human crystalline lens has the ability to accommodate both near and far vision needs and those viewing items are in focus. As one ages, the vision is compromised due to a decreasing ability to accommodate as one ages. This is called presbyopia.

Adaptive optics/powered lens products are positioned to address this and restore the ability to see items in focus. But what is required is knowing when to “activate/actuate” the optical power change. A manual indication or use of a key fob to signal when a power change is required is one way to accomplish this change. However, leveraging anatomical/biological conditions/signals may be more responsive, more user friendly and potentially more “natural” and thus more pleasant.

A number of things happen when we change our gaze from far to near. Our pupil size changes, our lines of sight from each eye converge in the nasal direction coupled with a somewhat downward component as well. However, to sense/measure these items are difficult; one also needs to filter out certain other conditions or noise, (e.g., blinks, in positions such as when one is lying down, or head movements).

At a minimum, sensing of multiple items may be required to remove/mitigate any false positive conditions that would indicate a power change is required when that is not the case. Use of an algorithm may be helpful. Additionally, threshold levels may vary from patient to patient, thus some form of calibration will likely be required as well.

An ophthalmic device may be configured with a variety of control parameters. However, a user may be unable to directly change (e.g., without the use of another device) the control parameters or otherwise control operation of the ophthalmic device. Thus, there is a need for more sophisticated ophthalmic devices that allow for direct user control. Ophthalmic devices such as contact lenses have limited area or volume for electronic components such as batteries or electronic circuits. This limits the energy available for powering electronic circuits, and it limits the complexity of circuitry that may be incorporated into such a lens. Further, it is desirable to minimize cost of such an ophthalmic lens sold in a consumer market. Therefore there is a need to provide for direct user control in a way that minimizes the area, volume, power and cost required to be compatible for use in ophthalmic devices.

### SUMMARY

According to one aspect, a method may include receiving, by a first sensor system disposed on or in a first ophthalmic device, first sensor data representing a first movement of a user, wherein the first ophthalmic device is disposed adjacent an eye of the user; determining, based on at least the first sensor data, that the first movement is indicative of a gesture mode trigger; causing, based on the gesture mode trigger, the first sensor system to enter a gesture mode; receiving, during the gesture mode, second sensor data; determining, based on the second sensor data, a second movement, wherein the second movement represents a change relative to one or more of a first axis and a second axis; determining a gesture of the user by comparing the second movement to one or more stored movements associated with corresponding gestures; and processing the gesture of the user.

According to another aspect, a system may include a first ophthalmic device configured to be disposed adjacent a first eye of a user, the first ophthalmic device comprising a first sensor system, the first sensor system comprising a first sensor and a first processor operably connected to the first sensor; and a second ophthalmic device configured to be disposed adjacent a second eye of the user, the second ophthalmic device comprising a second sensor system, the second sensor system comprising a second sensor and a second processor operably connected to the second sensor, wherein one or more of the first processor or the second processor is configured to, receive, from one or more of the first sensor or the second sensor, first sensor data representing a first movement of a user; determine, based on at least the first sensor data, that the first movement is indicative of a gesture mode trigger; cause, based on the gesture mode trigger, the first sensor system to enter a gesture mode; receive, during the gesture mode, second sensor data; determine, based on the second sensor data, a second movement, wherein the second movement represents a change relative to one or more of a first axis and a second axis; determine a gesture of the user by comparing the second movement to one or more stored movements associated with corresponding gestures; and process the gesture of the user.

According to another aspect, a system may include a first ophthalmic device configured to be disposed adjacent at least one of a right eye of a user or a left eye of the user; and a first sensor system disposed in or on the first ophthalmic device, the first sensor system comprising a first sensor and a first processor operably connected to the first sensor and configured to cause pairing of the first sensor system and a second sensor system disposed in or on a second ophthalmic device, wherein the first processor may be configured to: receive, from the first sensor, first sensor data representing a first movement of a user; determine, based on at least the first sensor data, that the first movement is indicative of a gesture mode trigger; cause, based on the gesture mode trigger, the first sensor system to enter a gesture mode; receive, during the gesture mode, second sensor data; determine, based on the second sensor data, a second movement, wherein the second movement represents a change relative to one or more of a first axis and a second axis; determine a gesture of the user by comparing the second movement to one or more stored movements associated with corresponding gestures; and process the gesture of the user.

### BRIEF DESCRIPTION OF THE OF THE DRAWINGS

FIG. 1 shows an exemplary implementation according to an embodiment of the present disclosure.

FIG. 2 shows a flowchart according to an embodiment of the present disclosure.

FIG. 3 shows another exemplary implementation according to an embodiment of the present disclosure.

FIG. 4 shows an example of focus determination.

FIG. 5 shows another flowchart according to an embodiment of the present disclosure.

FIG. 6 shows another flowchart according to an embodiment of the present disclosure.

FIG. 7 shows a diagram of a different directions of movements used for a gesture.

FIG. 8 is a diagrammatic representation of an exemplary electronic system incorporated into a contact lens for detecting eyelid position in accordance with the present disclosure.

FIG. 9 is a diagrammatic representation of an exemplary electronic system incorporated into a contact lens for detecting eyelid position in accordance with the present disclosure.

FIG. 10 is a diagrammatic representation of an exemplary electronic system incorporated into a contact lens for detecting eyelid position in accordance with the present disclosure.

FIG. 11A is a diagrammatic representation of an exemplary electronic system incorporated into a contact lens for detecting eyelid position in accordance with the present disclosure.

FIG. 11B is a diagrammatic representation of an exemplary electronic system incorporated into a contact lens for detecting eyelid position in accordance with the present disclosure.

FIG. 11C is a diagrammatic representation of an exemplary electronic system incorporated into a contact lens for detecting eyelid position in accordance with the present disclosure.

FIG. 12A is a diagrammatic representation of an exemplary electronic system incorporated into a contact lens for detecting eyelid position in accordance with the present disclosure.

FIG. 12B is a diagrammatic representation of an exemplary electronic system incorporated into a contact lens for detecting eyelid position in accordance with the present disclosure.

FIG. 13A is a diagrammatic representation of an exemplary electronic system incorporated into a contact lens for detecting eyelid position in accordance with the present disclosure.

FIG. 13B is a diagrammatic representation of an exemplary electronic system incorporated into a contact lens for detecting eyelid position in accordance with the present disclosure.

FIG. 13C is a diagrammatic representation of an exemplary electronic system incorporated into a contact lens for detecting eyelid position in accordance with the present disclosure.

FIG. 14 illustrates an exemplary ophthalmic lens comprising a combined blink detection and communication system in accordance with some embodiments of the present disclosure.

FIG. 15 illustrates a photodetector system in accordance with some embodiments of the present disclosure.

FIG. 16 is a diagrammatic representation of the geometry associated with various gaze directions in two dimensions in accordance with the present disclosure.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting. As will be appreciated by one skilled in the art, aspects of the present invention may be embodied as a system, method or computer program product.

The present methods and systems relate to an ophthalmic system comprising one or more ophthalmic devices, such as a system comprising at least one ophthalmic device for each eye of a user. In such a system, user control of the at least one ophthalmic device may be important.

An ophthalmic device may be configured for user control with or without an additional device, such as computing device, tablet, mobile device (e.g., mobile phone), smart device (e.g., smart apparel, smart watch, smart phone), or a customized remote control or key fob. In some scenarios, the user may not have access to an additional device to control the ophthalmic device. The present methods and systems describe an ophthalmic device configured to detect gestures by a user of the ophthalmic device. Movements of the user may be detected by the ophthalmic device by one or more sensors, such as accelerometers.

The ophthalmic device may be configured to associate commands, instructions, functions, and/or the like with corresponding gestures. For example, gestures may be correlated with available input commands, which may vary based on context. The gestures may be used to configure the ophthalmic device. The gestures may be used for calibration, pairing, changing operational modes, inputting custom settings (e.g., custom accommodation thresholds).

Calibration may be used (e.g., after or during paring) to configure ophthalmic devices to be more accurate. Because everyone's eyes are a bit different, (e.g., pupil spacing and location, lens-on-eye position, etc.), even at a fixed close distance, initial vergence angles will differ from patient to patient. It is important once ophthalmic devices (e.g., lenses) are placed in or on the eye to calibrate what the initial vergence angle is, so that differences in this angle can be assessed while in service. This value may be used for subsequent calibration calculations. Calibration may be initiated in response to a gesture from a user. During calibration, an ophthalmic device may request input from the user. The user may desire to reset, confirm, pause and/or otherwise control the calibration.

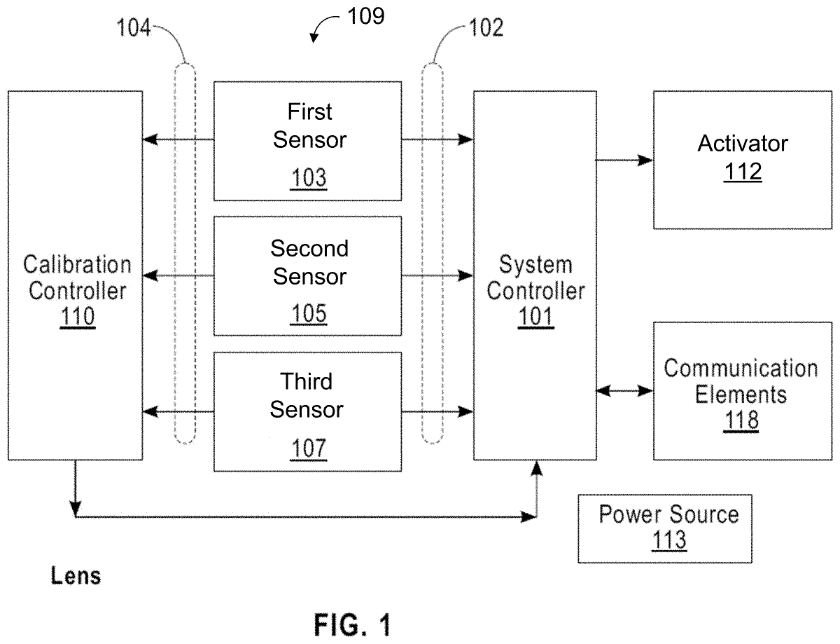

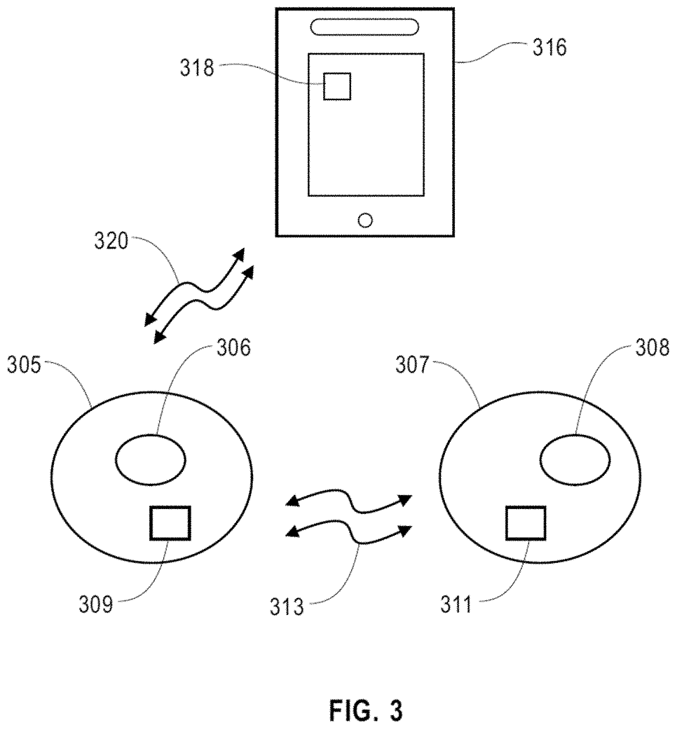

Now referring to FIG. 1, an exemplary implementation shows a system (e.g., or sensor system) according to an embodiment of the present invention. The system may be disposed in or on an ophthalmic device. The ophthalmic device may comprise a contact lens or an implantable lens, or a combination of both. The ophthalmic device may be configured to be disposed adjacent an eye of a user. Adjacent the eye may comprise being in contact with a surface of the eye, being disposed in a liquid in contact with the eye, resting on the eye, being disposed between the eye and the eye lid. The contact lens may comprise a soft or hybrid contact lens. The ophthalmic device may be part of system of at least two ophthalmic devices, as shown in FIG. 3.

A system controller 101 controls an activator 112 (e.g., lens activator) that changes the adaptive optics/powered lens (see FIG. 3) to control the ability to see both near and far items in focus. The system controller 101 may comprise a processor, memory, and/or the like. The system controller 101 (e.g., the processor) may be operably coupled to a sensor element 109. The system controller 101 receives signals 102 (e.g., data signals, control signals) from the sensor element 109.

The sensor element 109 may comprise a plurality sensors (103, 105 and 107). Examples of sensors may comprise a capacitive sensor, an impedance sensor, an accelerometer, a temperature sensor, a displacement sensor, a neuromuscular sensor, an electromyography sensor, a magnetomyography sensor, a phonomyography, or a combination thereof. The plurality of sensors (103, 105 and 107) may comprise a lid position sensor, a blink detection sensor, a gaze sensor, a convergence level sensor (e.g., vergence detection), an accommodation level sensor, a light sensor, a body chemistry sensor, neuromuscular sensor, or a combination thereof. The plurality of sensors (103, 105 and 107) may comprise one or more contacts configured to make direct contact with tear film of an eye of the user.

As an illustration, the plurality of sensors (103, 105 and 107) may comprise a first sensor 103, such as a first multidimensional sensor that includes an X-axis accelerometer. The plurality of sensors (103, 105 and 107) may comprise a second sensor 105, such as a second multidimensional sensor that includes a Y-axis accelerometer. The plurality of sensors (103, 105 and 107) may comprise a third sensor 107, such as a third multidimensional sensor that includes a Z-axis accelerometer. As another embodiment, the three axis accelerometers can be replaced by a three-axis magnetometer. Calibration would be similar because each axis would potentially require calibration at each extreme of each axis. The plurality of sensors (103, 105 and 107) further provide calibration signals 104 to a calibration controller 110. Although calibration controller 110 is shown as a separate component from the controller 101, it is understood that the hardware and/or logic defining such components may be implemented by a single controller unit, such as controller 101.

The calibration controller 110 may be configured to conduct a calibration sequence based on the calibration signals from the plurality of sensors (103, 105 and 107) as a result of user actions which is sensed by the plurality of sensors (103, 105 and 107) and provides calibration control signals 102 to the system controller 101. The system controller 101 may further receive from and supply signals to communication elements 118. Communication elements 118 allow for communications between user lens and other devices such a near-by smartphone. A power source 113 supplies power to all of the above system elements. The power source 113 may comprise a battery. The power source 113 may be either a fixed power supply, wireless charging system, or may be comprised of rechargeable power supply elements. Further functionality of the above embedded elements is described herein.

The plurality of sensors (103, 105 and 107) may be calibrated for determining vergence, gestures, and/or performing other operations. For example, sensors such as accelerometers may be calibrated. Offsets, due to manufacturing tolerances in the micro-electromechanical systems (MEMS) and/or the electronics, residual stress from or variation in the mounting on the interposer, etc. may cause variations with the algorithms and thus cause some errors in analyzing sensor data (e.g., errors in the measurement of vergence, in determining a gesture). In addition, human anatomy is different from person to person. For instance, eye to eye space can vary from 50 to 70mm and may cause a change in trigger points based on eye spacing alone. So there is a need to take some of these variables out of the measurement, thus calibration and customization may be performed when the ophthalmic device are on the user. This serves to improve the user experience by both adding the preferences of the user and to reduce the dependencies of the above-mentioned variations.

The plurality of sensors (103, 105 and 107) may measure acceleration both from quick movements and from gravity (9.81 m/s²). The plurality of sensors (103, 105 and 107) may produce a code that is in units of gravitational acceleration (g). The determination of vergence depends on the measurement of gravity to determine position, but other methods may depend on the acceleration of the eye. There are going to be differences and inaccuracies that will require base calibration before use calibration.

The current embodiment uses three sensors on each ophthalmic device. However, calibration may be done using two sensors, e.g., the first sensor 103 (e.g., X-axis accelerometer) and the second sensor 105 (e.g., Y-axis accelerometer). In either embodiment, each accelerometer has a full scale plus, full scale minus, and zero position. The errors could be offset, linearity, and slope errors. A full calibration would calibrate to correct all three error sources for all of axes sensors being used.

One way to calibrate the sensors is to move them such that each axis is completely perpendicular with gravity, thus reading 1 g. Then the sensor would be turned 180 degrees and it should read −1 g. From two points, the slope and intercept may be calculated and used to calibrate. This is repeated for the other two sensors. This is an exhaustive way of calibrating the sensors and thus calibrating the vergence detection system.

Another way is to reduce the calibration effort for the ophthalmic device is to have the wearer do just one or two steps. One way is to have the wearer look forward, parallel to the floor, at a distant wall. Measurements taken at this time may be used to determine the offset of each axis. Determining the offset for each axis in the directions where the user will spend most of the time provides a greater benefit to maintain accuracy.

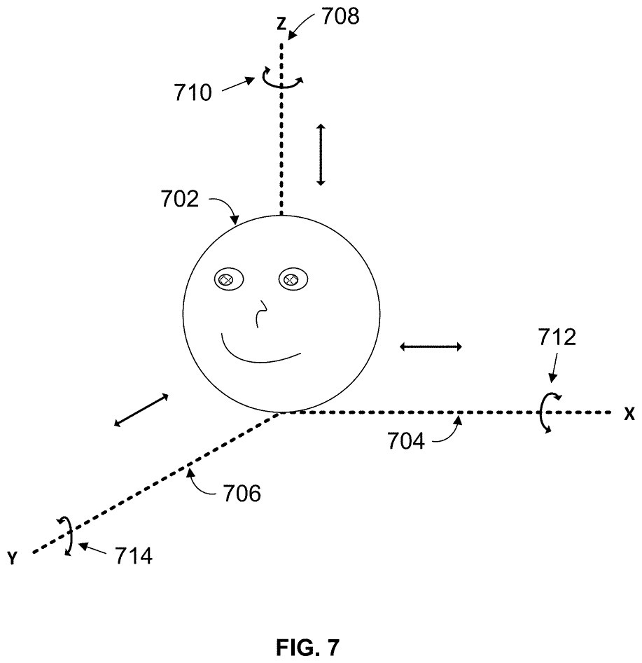

The plurality of sensors may transmit sensor data to the system controller 101 for gesture recognition. The system controller 101 may be configured to receive the sensor data and perform gesture recognition by analyzing the sensor data. The sensor data may represent a movement the user (e.g., or the ophthalmic device).The system controller 101 may be configured to determine a change in the movement of the user. FIG. 7 illustrates a set of axes and rotational angles used to quantify movements of a user 702. The user 702 may move along (e.g., in a positive or negative direction) one or more of an x-axis 704, a y-axis 706, and z-axis 708. One or more of the plurality of sensors may be oriented substantially along the x-axis 704, y-axis 706, or the z-axis 708. The x-axis 704, y-axis 706, and the z-axis 708 may be fixed or move relative to the position of the ophthalmic device.

The system controller 101 may determine the movement of the user based on the sensor data. The movement may comprise movement in a straight line, movement around an axis, and/or movement along any path. The movement may comprise movement from one position to another (e.g., distance), a speed and/or velocity of the change, acceleration of the change, and/or the like. The movement may comprise a movement along the x-axis 704 (e.g., movement left or right), a movement along the y-axis 706 (e.g., movement forward or backwards), a movement along the z-axis 708 (e.g., movement up or down), a combination thereof, and/or the like. The movement may comprise a movement in a yaw, a pitch, a roll, and/or a combination thereof. The yaw may comprise movement 710 around the z-axis 708. For example, the user may turn an eye (e.g., or head) left or right. The pitch 712 may comprise movement around the x-axis 704. For example, the user may tilt the eye (e.g., or head) up or down (e.g., or forward or backward). The roll may comprise movement 714 around the y-axis 706. For example, the user may tilt the head left or right. Movements not directly along our about an axis can also be sensed. For example, the user may look up to the right, which may be a combination of pitch and yaw. Accelerometers measure the static position of the sensors on each axis relative to gravity. Estimates of a user's movement may be determined from the change in position of the sensors from one time to a later time.

The controller 101 may be configured to determine the movement of the user as a relative movement. For example, a position may be determined relative to a prior position. A yaw value may be determined relative to a prior yaw value. A pitch value may be determined relative to a prior pitch value. A roll value may be determined relative to a prior roll value. The movement may be specific to one of the user's eyes and/or to both of the user's eyes. For example, a movement may be determined for both eyes individually. A movement in the left eye may be determined. A movement in the right eye may be determined.

The controller 101 may be configured to determine a command (e.g., instruction, input) based on the sensor data. For example, the controller 101 may match the movement to one or more available commands. The available commands may depend on context. For example, a first set of commands may be available for a first context. A second set of commands may be available for a second context. The first context may be default operation mode. In the default operation mode, the controller 101 may not be actively monitoring for gestures. For example, sensor data may be limited and one or more of the plurality of sensors may not be fully activated. In default operation mode, a first set of commands may comprise a command to enable gesture mode.

A command to enable gesture mode may be associated with a movement that would be unique and able to happen during normal operation (e.g., since the normal sensors will be shut down to conserve power). The command to enable gesture mode may be a gesture that can be differentiated from ordinary movements of the user. The command to enable gesture mode may have a complexity and/or range of movement outside of a user's typical movements. The command to enable gesture mode may be selected based on a history of movement for the user. For example, one or more movements may be removed as possible gestures based on a similarity to user movement. The command to enable gesture mode may comprise a multiple movements that are associated, such as a sequence of movements, or a first movement and a second movement (e.g., in a particular order or in no particular order). The command to enable gesture mode may comprise a first movement and a second movement. The first movement may be associated with a first trigger. The first trigger may comprise a movement that indicates a user is entering (e.g., has entered or will enter) a command. The second movement may comprise a movement associated with gesture control mode. The second movement may be performed before or after the first movement.

For example, the command to enable gesture mode (e.g., first movement and/or the second movement) may comprise a closing of an eyelid, moving of the eye or eyelid above or below a threshold speed, moving of the eye beyond a threshold angle (e.g., looking up, looking down, looking to the far left, looking to the far right), movement of the eye in a particular direction (e.g., crossing of the eyes, far upper left, far upper right, far lower left, far lower right) moving the eye in a circular pattern (e.g., rolling of the eye), a combination thereof, and/or the like. The first movement may comprise a first sequence of movements and the second movement may comprise a second sequence of movements.

As an illustration, the command to enable gesture mode may comprise a closing of one or more eyelids followed by moving one or more eyes (e.g., any movement, up, down, left right) while the eyelid(s) are closed. The command to enable gesture mode may comprise movement of one or more eyes into an extreme position (e.g., all the way up and to the right, beyond a threshold angle, such as a rotation angle, in a particular direction or in any direction) for a threshold time (e.g., two seconds). The command to enable gesture mode may comprise movement of one or more eyes into an extreme position followed by a blink pattern.

In an aspect, the controller 101 may filter out movements determined to be not intentional and determined to be not associated with enabling gesture mode. For example, if the controller 101 repeatedly enters or exits gesture mode within a threshold time, the controller 101 may increase a sensitivity threshold level associated with determining the command to enter the gesture mode. For example, a threshold time for the user to hold a gesture (e.g., closed eyes, extreme gaze) before being recognized as at least part of the command to enable gesture mode may be increased. The threshold angle that the user must move the eye before being recognized as at least part of the command to enable gesture mode may be increased. A number of repetitions that the user must perform a movement to be recognized as at least a part of the command to enable gesture mode may be increased.

The second context may comprise a gesture mode. In gesture mode, the controller 101 may have one or more navigational contexts (e.g., hierarchical contexts or menus). For example, available commands may comprise a command to perform calibration, a command to pair and/or unpair ophthalmic devices, a command to set a custom setting (e.g., accommodation setting). Each of these commands may be associated with a corresponding gesture. A gesture may be a single movement or sequence of movements. The movements may comprise eye movements, such as eyelid movements and movements of the eye ball. The eyelid may be closed, blinked in a pattern, and/or the like. The eye may be rotated in any direction. One gesture may be separated from another gesture by a specified punctuation gesture. For example, blinking twice or closing the eyes for a threshold time may indicate that the user has completed a gesture and/or is ready to enter another gesture.

The controller 101 may analyze one or more movements during a gesture window. The gesture window may be a time period for performing one or more gestures. The ophthalmic device may be configured to indicate that a gesture window is beginning and/or ending. For example, one or more changes in pitch and yaw (e.g., of the user's eye, user's head) may be stored during the gesture window. The one or more changes may be matched to corresponding movements associated with commands.

Analysis of sensor data may comprise categorization (e.g., matching) of sensor data based on one or more movements. Sensor values may comprise data in units of acceleration. The data may be associated with and/or comprise time values (e.g., to track different acceleration over time). A set of changes of acceleration over time may be analyzed to determine distance and/or direction of movement. The distance, the direction, and/or the acceleration values may be matched to a gesture. An example gesture may comprise user eye pitch movement X number of units (e.g., degrees, radians), a user eye yaw changed Y number of units, and/or the like, where X and Y may be any appropriate number. The gesture may comprise a direction of the movement and/or speed of movement. These values and others may be determined to match one or more movements to corresponding gestures. Once gestures are determined, a corresponding command may be determined. The command may be executed to cause a change in a setting, change in a context, navigate a menu, change a mode, and/or perform any other operation for which the ophthalmic device may be configured. As explained further herein, the sensor data may also comprise blink detection data, capacitance data, and/or the like. The blink detection data, capacitance data, and/or acceleration data may be analyzed separately or together to determine whether one or more movements (e.g., eye movements) are intended as a gesture by the user.

As a further illustration, an ophthalmic system may comprise a first ophthalmic device configured to be disposed adjacent a first eye of a user. The first ophthalmic device may comprise a first sensor system. The first sensor system may comprise a first sensor and a first processor operably connected to the first sensor. The ophthalmic system may comprise a second ophthalmic device (e.g., as shown in FIG. 3.) configured to be disposed adjacent a second eye of the user. The second ophthalmic device may comprise a second sensor system. The second sensor system may comprise a second sensor and a second processor operably connected to the second sensor. The first sensor system may comprise a first accelerometer configured to measure acceleration along an x-axis, a second accelerometer configured to measure acceleration along a y-axis perpendicular to the x-axis, a third accelerometer configured to measure acceleration along a z-axis perpendicular to the x-axis and the y-axis, a combination thereof, and/or the like. The second sensor system may comprise a first accelerometer configured to measure acceleration along an x-axis, a second accelerometer configured to measure acceleration along a y-axis perpendicular to the x-axis, a third accelerometer configured to measure acceleration along a z-axis perpendicular to the x-axis and the y-axis, a combination thereof, and/or the like. The ophthalmic system may be configured to map data of the first accelerometer, the second accelerometer, and the third accelerometer to one or more of the first axis or the second axis. For example, the first accelerometer, the second accelerometer, and the third accelerometer may be calibrated to the first axis and the second axis (e.g., or other axes associated with the user). Calibration data may be used to map the data of the first accelerometer, the second accelerometer, and the third accelerometer to one or more of the first axis or the second axis.

One or more of the first processor or the second processor may be configured to, receive, from one or more of the first sensor or the second sensor, first sensor data representing a first movement of a user. The first sensor data may be received during a calibration sequence. The first sensor data may be received during a power conservation mode in which one or more of the first sensor and the second sensor receive limited power or no power.

One or more of the first processor or the second processor may be configured to determine, based on at least the first sensor data, that the first movement is indicative of a gesture mode trigger. The gesture mode trigger may comprise a gesture and/or any movement that is associated with an instruction to enter (e.g., start, begin, enable) the gesture mode. For example, One or more of the first processor or the second processor may be configured to determine whether the first movement is indicative of the gesture mode trigger based on a determination of one or more of a length of time of the first movement, a complexity of the first movement, an intensity of the first movement, or a severity of an angle of movement of the eye.

One or more of the first processor or the second processor may be configured to cause, based on the gesture mode trigger, the first sensor system to enter a gesture mode. For example, the first sensor, the second sensor, and/or the like may be caused to change power mode (e.g., from low power to default power), caused to be activated (e.g., switched on), and/or the like. During gesture mode, the first processor and/or the second processor may receive sensor data and/or recognize gestures based on the sensor data. For example, one or more of the first processor or the second processor may be configured to receive, during the gesture mode, second sensor data.

One or more of the first processor or the second processor may be configured to determine, based on the second sensor data, a second movement. The second movement may represent a change relative to one or more of a first axis (e.g., x-axis), a second axis (e.g., y-axis), and a third axis (e.g., z-axis). The second movement may comprise a circular movement around one or more of the first axis, the second axis, and the third axis. The second movement may comprise a circular movement at a fixed distance around a reference point (e.g., origin of a spherical coordinate system) of one or more of the first axis or the second axis. The second movement may comprise a linear movement along one or more of the first axis, the second axis, and the third axis. The second movement may comprise a linear movement at a fixed angle (e.g., of a spherical coordinate system) from one or more of the first axis or the second axis. The change relative to one or more of the first axis, the second axis, and the third axis may comprise one or more of a change in yaw and a change of pitch.

As an illustration, the first movement may comprise closing an eyelid of the eye or moving the eye beyond a threshold angle. The first movement may comprise closing an eyelid of the eye and performing the second movement while the eyelid remains closed. The first movement may comprise moving the eye beyond a threshold angle for a threshold time and performing the second movement after performing the first movement.

One or more of the first processor or the second processor may be configured to determine a gesture of the user by comparing the second movement to one or more stored movements associated with corresponding gestures. The stored movements may be stored in database, table, and/or the like. The stored movements may be stored in the first ophthalmic device, the second ophthalmic device, at a remote location (e.g., remote service, user device), a combination thereof, and/or the like. Determining the gesture of the user by comparing the second movement to one or more stored movements associated with corresponding gestures may comprise determining the gesture of the user by comparing a change in one or more of yaw and pitch of the second movement to one or more changes in one or more of the yaw and the pitch of the stored movements associated with the corresponding gestures. Determining the gesture of the user by comparing the second movement to one or more stored movements associated with corresponding gestures may comprise determining the gesture of the user by comparing a degree in the change of the second movement to one or more degrees of change of the stored movements associated with the corresponding gestures. Determining the gesture of the user by comparing the second movement to one or more stored movements associated with corresponding gestures may comprise determining the gesture of the user by comparing a direction of the second movement to one or more directions of the stored movements associated with the corresponding gestures. Determining the gesture of the user by comparing the second movement to one or more stored movements associated with corresponding gestures may comprise determining the gesture of the user by comparing an intensity of the change of the second movement to one or more intensities of change of the stored movements associated with the corresponding gestures.

One or more of the first processor or the second processor may be configured to determine that the second movement matches one of the stored movement based on the difference between the second movement and the stored movement satisfying (e.g., being below) a threshold. If the difference satisfies the threshold, then the second movement may be recognized as at least a part of the gesture.

One or more of the first processor or the second processor may be configured to receive, during the gesture mode, third sensor data. An additional gesture of the user may be determined based on the third sensor data. The gesture and the additional gesture may be distinguished as two gestures based on a punctuation gesture configured to indicate a separation in gestures. The number of sensor data inputs and resultant calculations is used for example only. It is understood that any number of sensors, inputs, and gesture determinations may be used.

One or more of the first processor or the second processor may be configured to process the gesture of the user. The gesture may relate to an accommodation threshold. Processing the gesture may comprise changing the accommodation threshold. The gesture may relate to an operational mode. Processing the gesture may comprise changing the operational mode. The gesture may relate to a parameter of the ophthalmic device. Example parameters may comprise a custom accommodation threshold, a hysteresis parameter, a vergence parameter (e.g., eye spacing), a power state (e.g., on or off), and/or the like. Processing the gesture may relate to modifying the parameter. The gesture may relate to communication with a remote device. For example, a transceiver for communicating to the remote device may be turned on or off. The gesture may be associated with a message for another user (e.g., of the remote device or other device), such as a like, dislike, heartbeat, emoticon, arrival time, status, emotion, text message, and/or the like. The gesture may be associated with querying and/or commanding the remote device. For example, the gesture may be associated with querying and/or commanding a virtual assistant. The gesture may be associated with a command (e.g., for the virtual assistant), such as setting a user's location (e.g., home, room), setting an automation setting (e.g., lightening setting, which may be pre-programmed), ordering a good or merchandise, sending a text message, querying for news information, querying for sports team scores, sending an email, initiating a call, setting a calendar appointment, add a task, recording an audio and/or video communication of the user, querying a state of a device (e.g., home appliance, recording a picture of the user, a command for render information (e.g., on a television, phone, via a projection element of the ophthalmic device), and/or the like. The controller 101 may determine the command and/or query associated with the gesture. Additionally, or in the alternative, the controller 101 may send the gesture to the remote device for processing by the remote device.

User gestures may be used for further customization of an ophthalmic device. Further customization may be performed during and/or after calibration. Given that everyone is a little different, customizable features can prove a better user experience for all users than a one size fits all approach. When using the ophthalmic devices with just two modes, accommodation for a relatively close focus distance and gaze for a relatively far focus distance, then the point where this is a switch from gaze to accommodation one can have several parameters in addition to the switching threshold that would affect the user experience.

A threshold for going from gaze to accommodation is dependent on the user, the user's eye condition, the magnification of the ophthalmic device, and the tasks. For reading, the distance between the eye and book is about 30 cm, where computer usage is about 50 cm.A threshold set for 30 cm might not work well for computer work, but 50 cmwould work for both. However, this longer threshold distance could be problematic for other tasks by activating too early, depending on the magnification and the user's own eye condition. Thus, the ability to alter this threshold, both when the ophthalmic devices is first inserted and at any time afterwards as different circumstances could require different threshold points, provides the user customization to improve visibility, comfort and possibly safety. Even having several present thresholds is possible and practical, where the user would choose using the interfaces described here to select a different threshold. In addition, the user could alter the threshold or other parameters by re-calibrating per the embodiments of the present invention as described hereafter.

Still referring to FIG. 1, switching from gaze to accommodation, the system may use a first threshold as the activation point. However, going from accommodation to gaze the system may use a second threshold at a greater distance than the first threshold. The use of two threshold values with a “falling” threshold lower than a “rising” threshold is called hysteresis. Hysteresis is added in order to prevent uncertainty when the user is just at the threshold and there are small head movements which may cause it to switch back and forth from gaze to accommodation to gaze, etc. Most likely, the user will be looking at a distant target further than the second threshold when he wants to switch from accommodation to gaze, so the use of hysteresis is acceptable. The hysteresis value may be determined in several ways: one, the doctor fitting the ophthalmic devices can change it, two, the user can change this value via an ophthalmic device interface, and three, an adaptive algorithm can adjust it based on the habits of the user.

Custom Modes are common now in cars, i.e. sport, economy, etc. which allow the user to pick a mode based on anticipated activity where the system alters key parameters to provide the best experience. Custom Modes also may be integrated into the ophthalmic devices of the current embodiments. Calibration and customization settings may be optimized for a given mode of operation. If the user is working in the office, it is likely that the user will need to switch between states (e.g., gaze and accommodation), or even between two different vergence distances because of the nature of the tasks. Changes in the threshold, hysteresis, noise immunity, and possible head positions would occur to provide quicker transitions, possible intermediate vergence positions, and optimization for computer tasks, as well as, tasks that there is a lot if switching between gaze and accommodation. Thus, options to switch the ophthalmic device into different modes to optimize the ophthalmic device operation can provide an enhanced user experience. Furthermore, in an “Exercise” mode, the noise filtering is increased to prevent false triggering and additional duration of positive signal is required before switching to prevent false switching of the ophthalmic devices being triggered by stray glances while running. A “Driving” mode might have the ophthalmic device being configured for distant use or on a manual override only. Of course, various other modes that could be derived as part of the embodiments of the present invention. Gestures may be used to navigate and/or operate one or more of these custom modes. For example, a user may perform a first gesture to enter/exit exercise mode. A user may perform a second gesture to enter/exit driving mode. A user can perform gestures within any of these modes to change settings relevant to the corresponding mode.

In today's world, the smart phone is becoming a person's personal communications, library, payment device, and connection to the world. Apps for the smartphone cover many areas and are widely used. One possible way to interact with the ophthalmic device of the present invention is to use a phone app. The app could provide ease of use where written language instructions are used and the user can interact with the app providing clear instructions, information, and feedback. Voice activation options may also be included. For instance, the app provides the prompting for the sensor calibrations by instructing the user to look forward and prompting the user to acknowledge the process start. The app could provide feedback to the user to improve the calibration and instruct the user what to do if the calibration is not accurate enough for optimal operation. This would enhance the user experience.

Additional indicators, if the smart phone was not available, may be simple responses from the system to indicate start of a calibration cycle, successful completion, and unsuccessful completion. Methods to indicate operation include, but are not limited to, blinking lights, vibrating haptics drivers, and activating the ophthalmic device. Various patterns of activation of these methods could be interpreted by the user to understand the status of the ophthalmic device. The user can use various methods to signal the ophthalmic device that he/she is ready to start or other acknowledgements. For instance, the ophthalmic device could be opened and inserted into the eyes awaiting a command. Blinks or even closing one's eyes could start the process. The ophthalmic device (e.g., lens) then would signal the user that it is starting and then when it finishes. If the ophthalmic device requires a follow-up, it signals the user and the user signals back with a blink or eye closing.

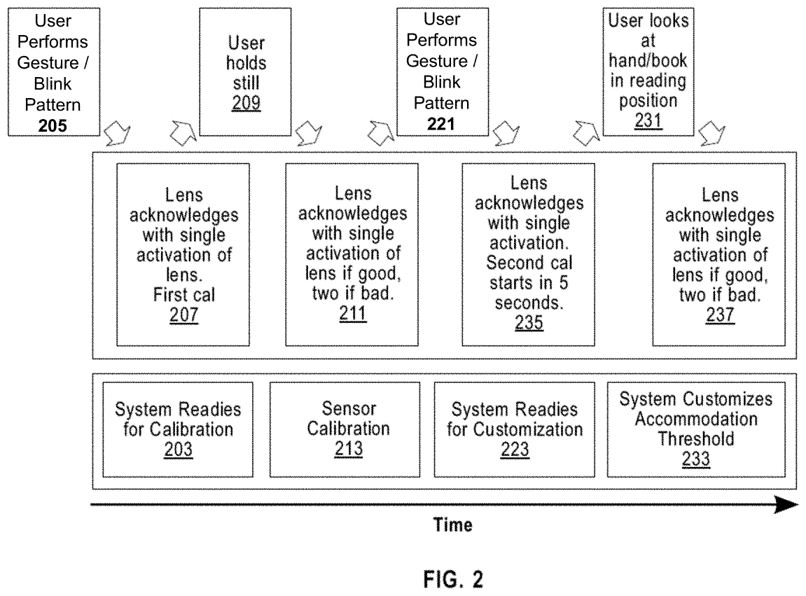

Referring to FIG. 2, one method according to an embodiment of the present invention is depicted. The process starts at an initial time (far left of the figure) and proceeds forward in time. Once the ophthalmic devices (see FIG. 3) are inserted, the system readies for calibration 203. The user performs a gesture and/or a blink pattern 205. The ophthalmic device (e.g., lens) may recognize the gesture. The ophthalmic device may acknowledge with a single activation of the ophthalmic device 207 as part of a first calibration. The user holds still 209 as the system and the sensor calibration 213 starts. The ophthalmic device may acknowledge with a single activation of the ophthalmic device if the first stage of calibration is good 211. If the initial calibration is bad, then the ophthalmic device may acknowledge with a double activation 211. If the calibration is bad, then the user must restart the calibration process 205. After the initial calibration, the system is ready for customization 223. The user performs another gesture and/or blink pattern 221. The ophthalmic device (e.g., lens) may recognize the gesture. The ophthalmic device may acknowledge with a single activation of the ophthalmic device and a second calibration, customization, is started in some fixed time 235 as part the system customization accommodation threshold 233. The user then looks at either their hand or a book at reading position 231. The ophthalmic device may acknowledge with a single activation of the ophthalmic device if the second stage of calibration customization is good 237. If the second stage of calibration customization is bad, then the user must restart the calibration customization process 221. Once the ophthalmic device may acknowledge with a single activation of the ophthalmic device that the second stage of calibration customization is good 237 the system has the completed customization accommodation calibration and the ophthalmic devices are ready for full use by the user. It should be noted that such method is not limited to the accommodation calibration. A similar approach can be used for other calibration operations and/or customization.

Other embodiments to customize the threshold can be accomplished. One way is to have the user's doctor determine the comfortable distance for the user by measuring the distance between the eyes of the patent, the typical distance for certain tasks, and then calculate the threshold. From there, using trial and error methods, determine the comfortable distance. Various thresholds can be programmed into the ophthalmic device and the user can select the task appropriate threshold.

Another method is to allow the user to select to perform pairing and/or calibration himself. The user may start pairing and/or calibration by performing a gesture (e.g., during gesture mode). The gesture may cause the ophthalmic device to begin the calibration and/or pairing. The ophthalmic device can use the same system that it uses to measure the user's relative eye position to set the accommodation threshold at the user's preference of a distance at which to activate the extra ophthalmic device power. There is an overlap where the user's eyes can accommodate unassisted to see adequately and where the user's eyes also can see adequately with the extra power when the ophthalmic device is active. At what point to activate may be determined by user preference. Providing a means for the user to set this threshold, improves the comfort and utility of the ophthalmic devices. An example procedure follows this sequence:

The user performs a gesture associated with calibration and/or customization sequence;

The ophthalmic device recognizes the gesture and begins the calibration and/or customization sequence;

The user prompts the system to start the sequence (e.g., by performing another gesture, such as a gesture associated with start/begin). Initially the system may prompt the user as a part of the initial calibration and customization;

The ophthalmic devices are activated. The ability to achieve a comfortable reading position and distance requires the user to actually see a target, thus the ophthalmic devices are in the accommodation state;

The user focuses on a target which is at a representative near distance while the system determines the distance based on the angles of the eyes by using the sensor information (accelerometers or magnetometers); after one or more measurements and optionally use of noise reduction techniques the system calculates an estimated near distance and indicates that it has finished,

The system may determine a new near threshold angle or distance based on the estimated near distance. A slight offset may be subtracted to effectively place the near threshold a little closer. The system may determine a new far threshold angle or distance by adding an offset to the estimated near distance, thus creating hysteresis. This is necessary to move the far threshold slightly longer (angle slightly lower) in order for the system to remain in the same accommodative state and effectively ignore small head or body position differences the user is in a relatively static or constant reading or viewing distance. The value of this hysteresis could be altered by an algorithm that adapts to user habits. Also, the user could manually change the value if the desired by having the system prompt the user to move the focus target to a position that the user does not want the ophthalmic device to activate while focusing on the target. The system would deactivate the ophthalmic device and then determine this distance. The Hysteresis value is the difference in the far distance or angle and the near distance or angle. Ophthalmic devices are now on dependent on the new threshold and hysteresis values.

To have a good user experience, the user may receive confirmation that the system has completed any adjustments or customization. In addition, the system may be configured to determine if the user performed these tasks properly and if not, and then request that the user preforms the procedure again. Cases that prevent proper customization and adjustment may include excessive movement during measurement, head not straight, lens out of tolerance, etc. The interactive experience will have far less frustrated or unhappy users.

Feedback may be given through various means. Using a phone app provides the most flexibility with the screen, cpu, memory, internet connection, etc. The methods as discussed for calibration per the embodiments of the present invention can be done in conjunction with the use of a smartphone app with use of the communication elements as described in reference to FIG. 1 and with reference to FIG. 3 hereafter. Additionally, feedback may be provided to the ophthalmic device based on one or more gestures (e.g., whether in gesture mode or not).

As a part of continual improvement for the ophthalmic devices, data for the ophthalmic devices can be collected and sent back to the manufacturer (anonymously) via the smartphone app to be used to improve the product. Collected data includes, but not limited to, accommodation cycles, errors, frequency that poor conditions occur, number of hours worn, user set threshold, etc.

Other methods to indicate operation include, but not limited to, blinking lights, vibrating haptics drivers, and activating the ophthalmic devices. Various patterns of activation of these methods could be interpreted by the user to understand the status or state of the ophthalmic device, the user, or other communication of information.

Referring now to FIG. 3, shown is another exemplary implementation according to an embodiment of the present invention in which sensing and communication may be used to communicate between a pair of ophthalmic devices (305, 307), such as contact lenses. Pupils (306, 308) are illustrated for viewing objects. The ophthalmic devices (305, 307) include embedded elements, such as those shown in FIG. 1. The embedded elements (309, 311) included for example 3-axis accelerometers/magnetometers, lens activators, calibration controller, a system controller, memory, power supply, and communication elements as is described in detail subsequently. A communication channel 313 between the two ophthalmic devices (305, 307) allows the embedded elements to conduct calibration between the ophthalmic devices (305, 307). Communication may also take place with an external device, for example, spectacle glasses, key fob, dedicated interface device, or a smartphone.

As an example, communication between the ophthalmic devices (305, 307) can be important to detect proper calibration. Communication between the two ophthalmic devices (305, 307) may take the form of absolute or relative position, or may simply be a calibration of one ophthalmic device to another if there is suspected eye movement. If a given ophthalmic device detects calibration different from the other ophthalmic device, it may activate a change in stage, for example, switching a variable-focus or variable power optic equipped contact lens to the near distance state to support reading. Other information useful for determining the desire to accommodate (focus near), for example, lid position and ciliary muscle activity, may also be transmitted over the communication channel 313. It should also be appreciated that communication over the channel 313 could comprise other signals sensed, detected, or determined by the embedded elements (309, 311) used for a variety of purposes, including vision correction or vision enhancement.

The communications channel (313) comprises, but is not limited to, a set of radio transceivers, optical transceivers, ultrasonic transceivers, near field transceivers or the like that provide the exchange of information between both ophthalmic devices and/or between the ophthalmic devices and a device such as a smart phone, FOB, or other device used to send and receive information. The types of information include, but are not limited to, current sensor readings showing position, the results of system controller computation, synchronization of threshold and activation. In addition, the device or smart phone could upload settings, sent sequencing signals for the various calibrations, and receive status and error information from the ophthalmic devices.

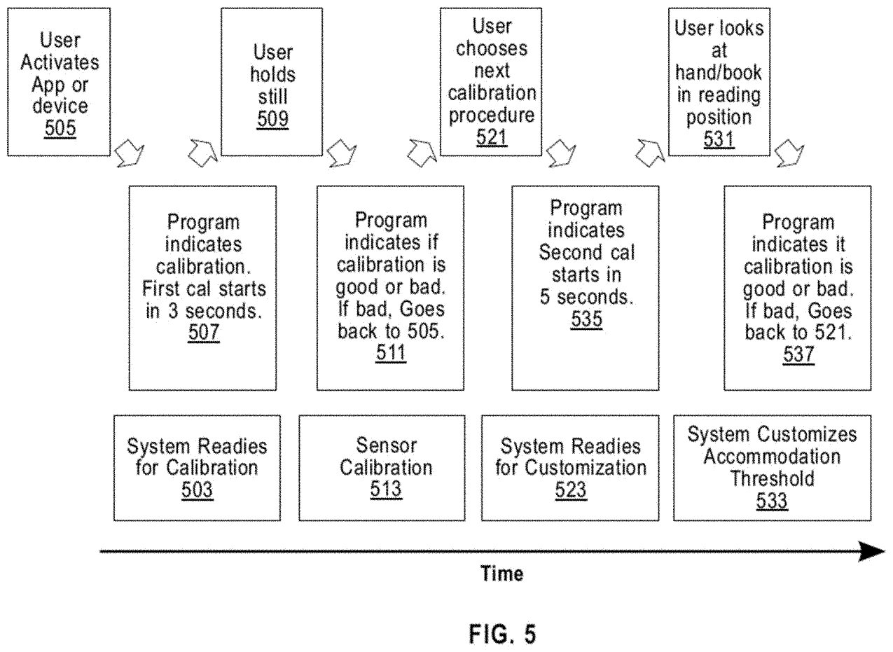

Still referring to FIG. 3, the ophthalmic devices (305, 307) may further communicate with a smart phone (316) or other external communication device. Specifically, an app 318 on the smart phone (316) may communicate to the ophthalmic devices (305, 307) via a communication channel (320). The functionally of the app (318) may follow the process as outlined with referenced to FIG. 5 (described hereafter) and instructs the user when to perform the required eye movements. In addition, the device or smart phone (316) could upload settings, send sequencing signals for the various calibrations, and receive status and error information from the ophthalmic devices (305, 307).

The smart phone 316 may be configured to manage gestures. For example, the smart phone 316 may store one or more movements associated with gestures. The smart phone 316 may store one or more commands associated with gestures. The app 318 may indicate one or more gestures to a user. For example, a list of commands and representations (e.g., image, video) of corresponding gestures may be stored in the app. The app may indicate different commands for different navigational contexts (e.g., gesture mode, calibration sequence, customization sequence, pairing sequence).

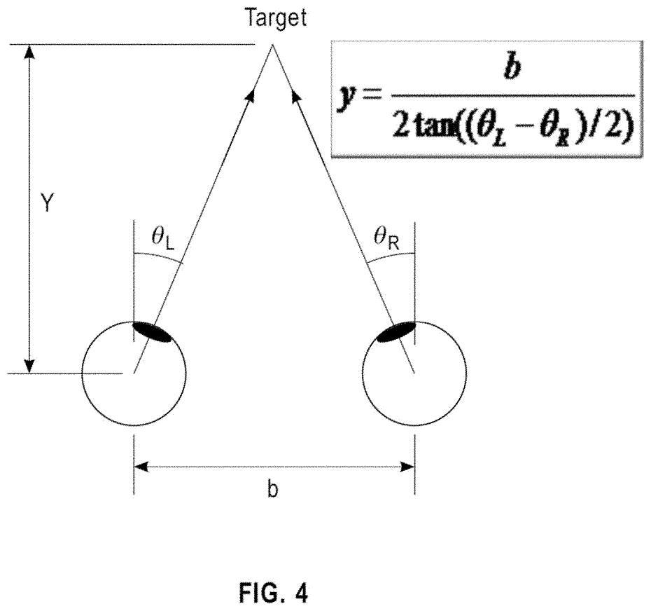

In reference to FIG. 4, when observing an object in each eye the visual axis points toward the object or Target. Since the two eyes are spaced apart (distance b) and the focal point is in front, a triangle is formed. Forming a triangle allows the relationship of angles (8L and 8R) of each visual axis to the distance (Y) the object is from the eyes to be determined. It is understood that knowing the angles and the distance between the eyes (and applying formulas such as those shown below) would allow a system to determine gestures associated with eye position. Example formulas for distance (y) include formula A and B below, where A represents the basis formula and B represent a derivation for approximating straight ahead viewing or substantially straight ahead viewing:

$${\begin{matrix}y = \frac{b}{tan {θ}_{L} - tan {θ}_{R}}\end{matrix}}_{( A )} {\begin{matrix}y = \frac{b}{2 tan ( ( {θ}_{L} - {θ}_{R} ) / 2 )}\end{matrix}}_{( B )}$$

Referring to FIG. 5, another method according to an embodiment of the present invention is depicted. The process starts at an initial time (far left of the figure) and proceeds forward in time. Once the ophthalmic devices (see FIG. 3) are inserted, the system readies for calibration 503. User activates an application (app) or device 505. The app program indicates calibration and the first calibration starts in 3 seconds 507 as part of a first calibration. The user holds still 509 as the system and the sensor calibration 513 starts. The program indicates if calibration is good or bad 511. If calibration is bad the program restarts and goes back (to step 505) 511. After the initial calibration, the system is ready for customization 523. The user chooses the next calibration procedure 521. The program indicates the second calibration will start in 5 seconds 535 as part the system customization accommodation threshold 533. The user then looks at either their hand or a book at reading position 531. The program determines if second stage of calibration customization is good 537. If the second stage of calibration customization is bad, then the user must restart the calibration customization process 521. Once the program acknowledges that the second stage of calibration customization is good 537 the system has the completed customization accommodation calibration and the ophthalmic devices are ready for full use by the user.

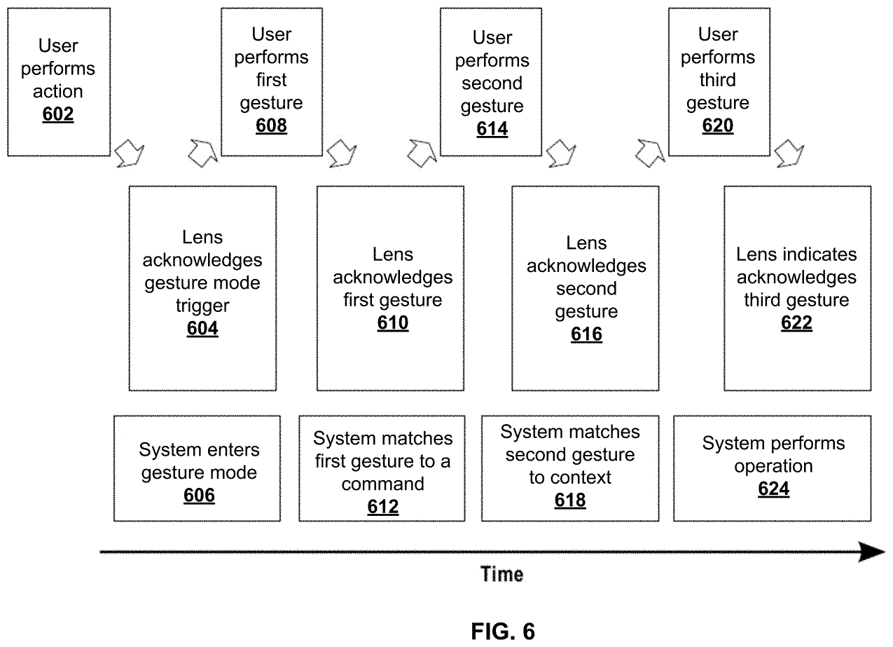

Referring to FIG. 6, another method according to an embodiment of the present invention is depicted. Once the ophthalmic devices (see FIG. 3) are inserted, the system readies for normal operation. The user performs an action 602. The action can be any movement, such as a gesture, an eye blink, focusing at a certain distance, interacting with an interface element on an application, and/or the like. First sensor data representing the action (e.g., a first movement) of the user may be received by the system. The system (e.g., or ophthalmic device) may determine that the action is indicative of a gesture mode trigger (e.g., associated with triggering a gesture mode). The action may be determined to be a gesture mode trigger based on at least the first sensor data. The lens acknowledges the gesture mode trigger 604 (e.g., via single activation of the lens. The system may be caused, based on the gesture mode trigger, to enter the gesture mode 606.

The user performs a first gesture 608. The system can recognize the first gesture. The ophthalmic device (e.g., lens) may acknowledge the first gesture (e.g., that the first gesture was recognized as a stored gesture) 610. The system may process the first gesture. The system may match the first gesture to a command 612. The command may be a navigational command, such as a command to enter a navigational context. For example, the command can be a command to enter a calibration sequence, customization sequence, pairing sequence, and/or the like.

The user performs a second gesture 614. Second sensor data may be received (e.g., during the gesture mode). The system may recognize the second gesture (e.g., based on the second sensor data). For example, the system may determine a second movement based on the second sensor data. The second movement may represent a change relative to one or more of a first axis, a second axis, and a third axis. The second gesture may be determined by comparing the second movement to one or more stored movements associated with corresponding gestures. The ophthalmic device (e.g., lens) may acknowledge the second gesture (e.g., that the first gesture was recognized as a stored gesture) 616. The system may process the second gesture. The system may associate a command with the second gesture based on the navigational context 618. For example, each of a navigational context may have gestures assigned to commands that are specific to the navigational context. The system may execute the command.

The user performs a third gesture 620. The system may recognize the third gesture. The ophthalmic device (e.g., lens) may acknowledge the third gesture (e.g., that the first gesture was recognized as a stored gesture) 622. The system may process the third gesture. The system may perform an operation 622. For example, the system may change a setting, such as an accommodation threshold. The system may change a setting as part of the navigational context.

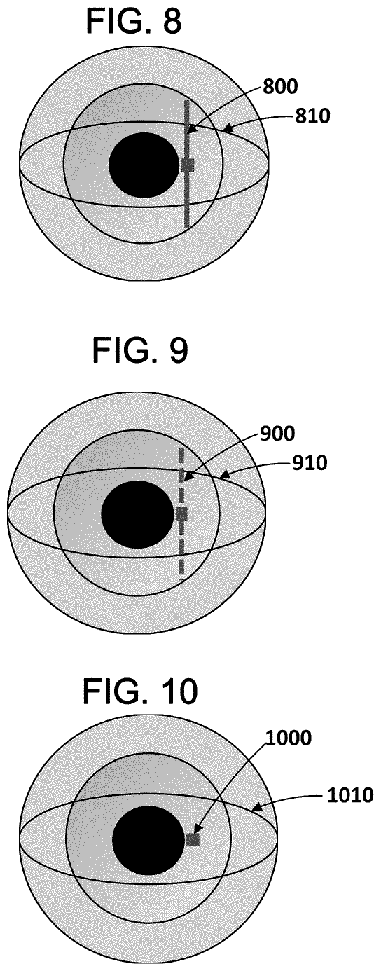

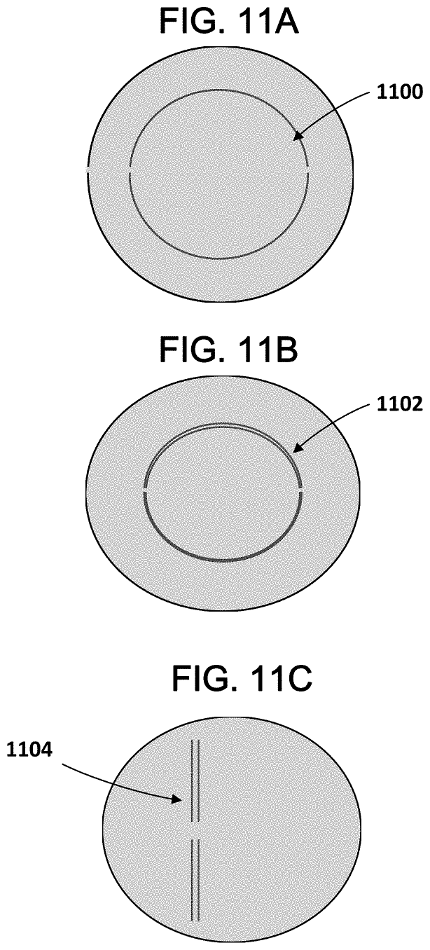

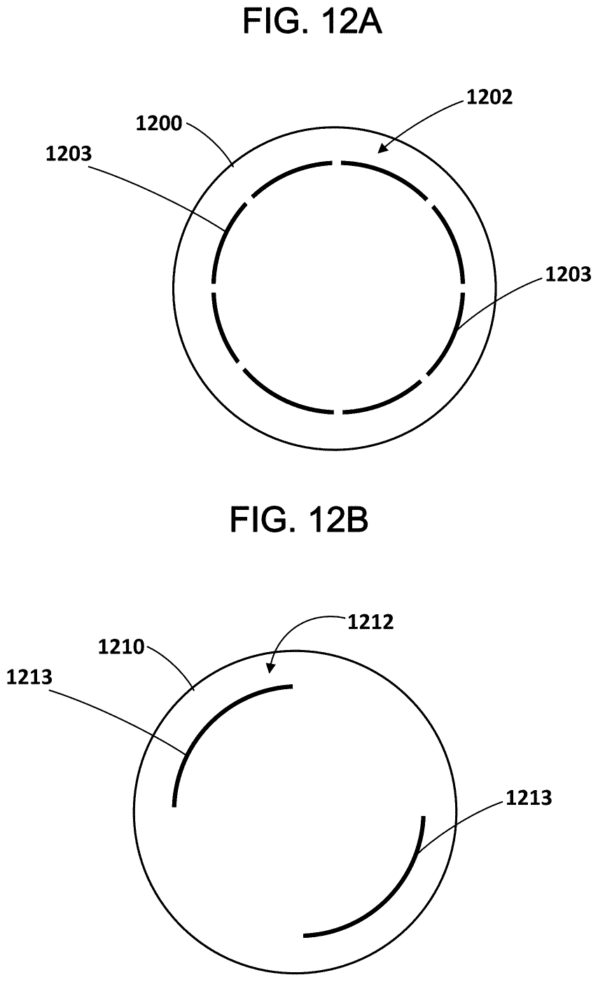

In an aspect, gesture detection associated with movement of an eyelid or an eye may be determined based on one or more capacitive touch sensors. The capacitive touch sensors may be used to track movements of the eye of the use. The movements may be recognized as a gesture, such as a trigger to enter a gesture mode or a gesture during gesture mode. The capacitive touch sensors may be used to sense a capacitance adjacent an eye of the user of the ophthalmic device. As an example, the capacitive touch sensors may be configured to detect a capacitance that may be affected by a position of one or more of an upper eyelid and a lower eyelid of the user. As such, the sensed capacitance may be indicative of a position of the eyelid(s) and may represent a gaze or position of the eye. One or more of the capacitive touch sensors may be configured as linear sensor 800 (FIG. 8), a segmented sensor 900 (FIG. 9), and/or an integrating sensor 1000 (FIG. 10) configured to integrate a response over a sensor area. In the various configurations illustrated in FIGS. 8-10, the sensors 800, 900, 1000 may be configured to sense a capacitance due at least in part to a position of an eyelid 810, 910, 1010. Additionally, or alternatively, the sensors may be configured as a dual wire single capacitive sensor 1100 (FIG. 11A) and/or a dual wire dual capacitive sensor 1102 (FIG. 11B) having a generally curvilinear configuration. Additionally, or alternatively, the sensors 504 may be configured as a dual wire dual capacitive sensor 1104 (FIG. 11C) having a generally straight configuration. Additionally, or alternatively, the sensors may be configured in a generally annular configuration. Any number of sensors may be configured. For example, FIG. 12A illustrates an ophthalmic device 1200 comprising a sensor 1202 having eight traces or electrodes 1203 configured in a generally annular configuration. As a further example, FIG. 12B illustrates an ophthalmic device 1210 comprising a sensor 1212 having two traces or electrodes 1213 configured in a generally annular configuration, wherein each of the electrodes 1213 have a generally curvilinear shape and extend less than half of the circumference of the ophthalmic device 1210.

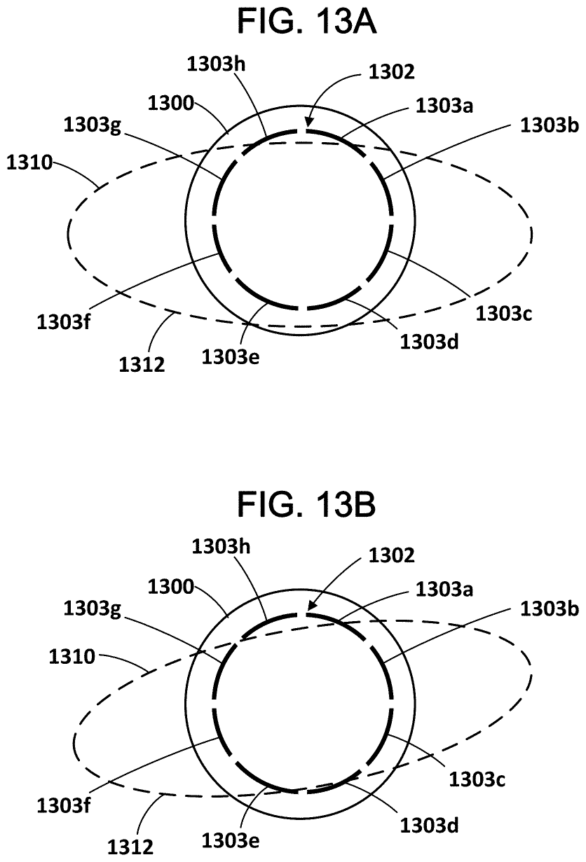

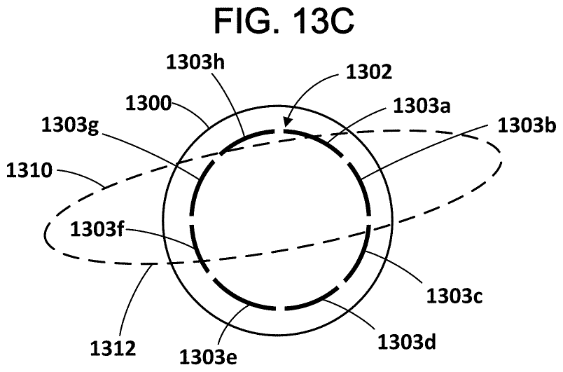

FIGS. 13A, 13B, and 13C illustrate various positions of the eyelids 1310, 1312 as they may overlay the electrodes 1303 of a sensor 1302. As the gaze of a user changes, the position of the eyelids 1310, 1312 changes and may overlay different portions of the sensor 1302, thereby causing fluctuation in capacitance measurement taken from one or more of the electrodes 1303.

As shown in FIG. 13A, a gaze angle may be taken as a zero degree down gaze, where the upper eyelid 1320 overlays electrode 1303a and electrode 1303h and the lower eyelid 1312 overlays none of the electrodes 1303a-h. As such, the capacitance measurement at each of the electrodes 1303a-h may provide a capacitive sensing signature representative of the zero degree down gaze. In particular, electrode 1303a and electrode 1303h may detect a capacitance measurement indicative of the overlaying upper eyelid 1320. This information may be stored, for example, via a system controller 101 (FIG. 1) and may be referenced subsequently. As an example, when a subsequent capacitance measurement is found to be the same or similar to the stored measurement, the positions of the eyelids 1320, 1312 may be determined. Additionally, or alternatively, the eye gaze may be determined. As a further example, the stored measurements may represent the activation or deactivation of a particular electrode 1303 have a sensed capacitance over a preset threshold. For example, the stored measurements may indicate the for a zero degree down gaze, the electrodes 1303a, 1303h will be activated, but the other electrodes 1303b-1303g will be deactivated. Capacitance measurements may be absolute, binary, actual, and/or conditioned in various manners.

As shown in FIG. 13B, a gaze angle may be taken as a twenty-five degree down gaze, where the upper eyelid 1320 overlays electrode 1303a and electrode 1303h and the lower eyelid 1312 overlays electrode 1303d and electrode 1303e. As such, the capacitance measurement at each of the electrodes 1303a-h may provide a capacitive sensing signature representative of the twenty-five degree down gaze. In particular, electrode 1303a and electrode 1303h may detect a capacitance measurement indicative of the overlaying upper eyelid 1320. Electrode 1303d and electrode 1303e may detect a capacitance measurement indicative of the overlaying lower eyelid 1312. This information may be stored, for example, via a system controller 101 (FIG. 1) and may be referenced subsequently. As an example, when a subsequent capacitance measurement is found to be the same or similar to the stored measurement, the positions of the eyelids 1320, 1312 may be determined. Additionally, or alternatively, the eye gaze may be determined. The eye gaze (e.g., or eye gaze angle) and/or the position of an eyelid may be used to determine whether a movement is intentional and/or relates to a gesture (e.g., to control an ophthalmic device). As a further example, the stored measurements may represent the activation or deactivation of a particular electrode 1303 have a sensed capacitance over a preset threshold. For example, the stored measurements may indicate the for a zero degree down gaze, the electrodes 1303a, 1303d, 1303e, 1303h will be activated, but the other electrodes will be deactivated. Capacitance measurements may be absolute, binary, actual, and/or conditioned in various manners.

As shown in FIG. 13C, a gaze angle may be taken as a forty-five degree down gaze, where the upper eyelid 1320 overlays electrode 1303a and electrode 1303h and the lower eyelid 1312 overlays electrode 1303c and electrode 1303f. As such, the capacitance measurement at each of the electrodes 1303a-h may provide a capacitive sensing signature representative of the forty-five degree down gaze. In particular, electrode 1303a and electrode 1303h may detect a capacitance measurement indicative of the overlaying upper eyelid 1320. Electrode 1303c and electrode 1303f may detect a capacitance measurement indicative of the overlaying lower eyelid 1312. This information may be stored, for example, via a system controller 101 (FIG. 1) and may be referenced subsequently. As an example, when a subsequent capacitance measurement is found to be the same or similar to the stored measurement, the positions of the eyelids 1320, 1312 may be determined. Additionally, or alternatively, the eye gaze may be determined. The capacitance measurement, the position of an eyelid, eye angle, and/or the eye gaze may be used to determine whether a movement is intentional and/or relates to a gesture (e.g., for controlling an ophthalmic device). For example, the capacitance measurement, the position of an eyelid, eye angle, and/or the eye gaze may be analyzed with timing information (e.g., length of time a position is held), historical information (e.g., previous and/or subsequent movements) to determine whether a movement is intentional and/or relates to a gesture (e.g., for controlling an ophthalmic device). As a further example, the stored measurements may represent the activation or deactivation of a particular electrode 1303 have a sensed capacitance over a preset threshold. For example, the stored measurements may indicate the for a zero degree down gaze, the electrodes 1303a, 1303c, 1303f, 1303h will be activated, but the other electrodes will be deactivated. Capacitance measurements may be absolute, binary, actual, and/or conditioned in various manners.

The capacitive touch sensors may comprise a variable capacitor, which may be implemented in a physical manner such that the capacitance varies with proximity or touch, for example, by implementing a grid covered by a dielectric. Sensor conditioners create an output signal proportional to the capacitance, for example, by measuring the change in an oscillator comprising the variable capacitor or by sensing the ratio of the variable capacitor to a fixed capacitor with a fixed-frequency AC signal. The output of the sensor conditioners may be combined with a multiplexer to reduce downstream circuitry.

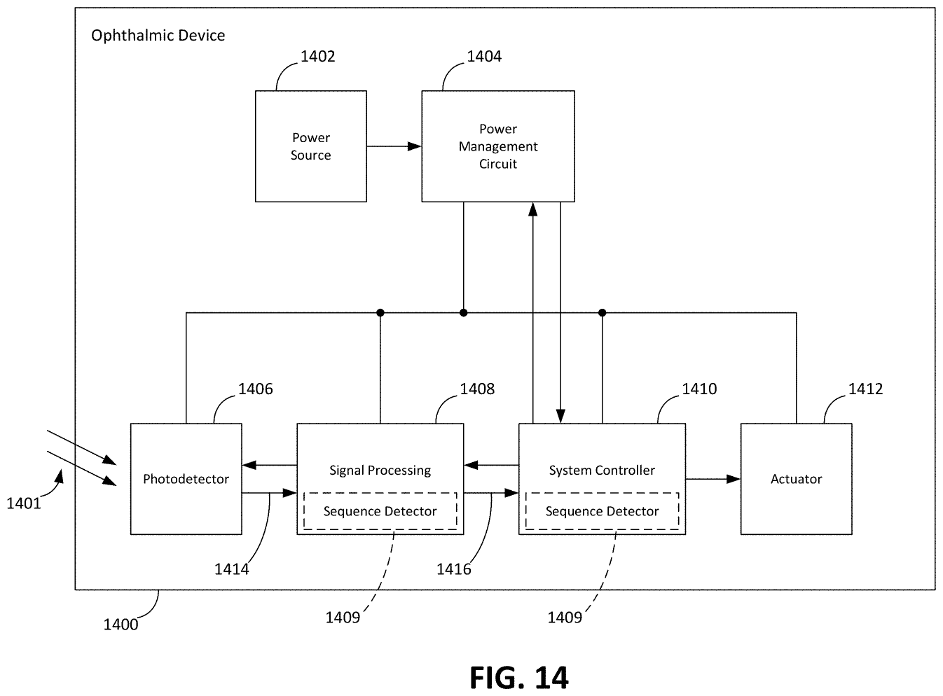

FIG. 14 illustrates the geometric systems associated with various gaze directions. FIG. 14 is a top view. Eyes 1401 and 1403 are shown gazing upon various targets labeled A, B, C, D, and E. A line connects each eye 1401 and 1403 to each 15 target. A triangle is formed by each of the two lines connecting the eyes 1401 and 1403 with a given target in addition to a line connecting both eyes 1401 and 1403. As may be seen in the illustration, the angles between the direction of gaze in each eye 1401 and 1403 and the line between the two eyes 1401 and 1403 varies for each target. These angles may be measured by the sensor system, determined from indirect sensor measurements, or may only be shown for illustrative purposes. Although shown in two dimensional space for simplicity of illustration, it should be apparent that gaze occurs in three-dimensional space with the corresponding addition of an additional axis. Targets A and B are shown relatively near to the eyes 1401 and 1403, for example, to be read with near-focus accommodation. Target A is to the right of both eyes 1401 and 1403, hence both eyes 1401 and 1403 are pointing right. Measuring the angle formed anticlockwise between the horizontal axis, illustrated collinear with the line connecting the two eyes 1401 and 1403, and direction of gaze, both angles are acute for target A. Now referring to target B the eyes 1401 and 1403 are converged on a target in front of and between both eyes 1401 and 1403. Hence the angle, previously defined as anticlockwise from the horizontal axis and the direction of gaze, is obtuse for the right eye 1403 and acute for the left eye 1401. A suitable sensor system will differentiate the positional difference between targets A and B with suitable accuracy for the application of concern. Target C is shown at intermediate distance for the special case of the right eye 1403 having the same direction of gaze and angle as target B. The gaze direction varies between targets B and C allowing a gaze direction determination system using inputs from [ophthalmic devices on] both eyes 1401 and 1403 to determine the direction of gaze. Further, a case could be illustrated where another target F lies above target B in three-dimensional space.

In FIG. 14, the angles from the horizontal axis would be identical to those illustrated for target B. However, the angles normal to the page extending in three-dimensional space would not be equal between the targets. Finally, targets D and E are shown as distant objects. These examples illustrate that as the object under gaze is farther away, the angular difference at the eyes 1401 and 1403 between distant points becomes smaller. A suitable system for detecting gaze direction would have sufficient accuracy to 15 differentiate between small, distant objects.

The present methods and systems may determine one or more angles of movement associated with the gaze of the user (e.g., regardless of whether the user's eyelids are open or closed. If the angle is greater than a threshold, then the gaze may be determined to be associated with a gesture. For example, if the angle is greater than an angle associated with target C or target A, then the gaze may be recognized as at least part of a gesture. Similarly, if the eye rotates forward or backward (e.g., looking up or down) beyond a threshold angle, then gaze and/or gaze angle of the user may be used to determine whether a movement is at least part of a gesture.

In another aspect, gestures of the user associated with blinking may be determined based on a blink detection algorithm. A blink detection algorithm is a component of the system controller which detects characteristics of blinks, for example, is the lid open or closed, the duration of the blink, the inter-blink duration, and the number of blinks in a given time period. One algorithm in accordance with the present disclosure relies on sampling light incident on the eye at a certain sample rate. Pre-determined blink patterns may be stored and compared to the recent history of incident light samples. When patterns match, the blink detection algorithm may detect a gesture associated with blinking. The gesture may comprise a command to enable gesture mode and/or a gesture while gesture mode is enabled.

Blinking is the rapid closing and opening of the eyelids and is an essential function of the eye. Blinking protects the eye from foreign objects, for example, individuals blink when objects unexpectedly appear in proximity to the eye. Blinking provides lubrication over the anterior surface of the eye by spreading tears. Blinking also serves to remove contaminants and/or irritants from the eye. Normally, blinking is done automatically, but external stimuli may contribute as in the case with irritants. However, blinking may also be purposeful, for example, for individuals who are unable to communicate verbally or with gestures can blink once for yes and twice for no. The blink detection algorithm and system of the present disclosure utilizes blinking patterns that cannot be confused with normal blinking response. In other words, if blinking is to be utilized as a means for controlling an action (e.g., or as a gestures associated with controlling an ophthalmic device), then the particular pattern selected for a given action cannot occur at random; otherwise inadvertent actions may occur. As blink speed may be affected by a number of factors, including fatigue, eye injury, medication and disease, blinking patterns for control purposes preferably account for these and any other variables that affect blinking. The average length of involuntary blinks is in the range of about one hundred (100) to four hundred (400) milliseconds. Average adult men and women blink at a rate of ten (10) involuntary blinks per minute, and the average time between involuntary blinks is about 0.3 to seventy (70) seconds.

An exemplary embodiment of a blink detection algorithm may be summarized in the following steps:

1. Define an intentional “blink sequence” that a user will execute for positive blink detection.

2. Sample the incoming light level at a rate consistent with detecting the blink sequence and rejecting involuntary blinks.

3. Compare the history of sampled light levels to the expected “blink sequence,” as defined by a blink template of values.

4. Optionally implement a blink “mask” sequence to indicate portions of the template to be ignored during comparisons, e.g. near transitions. This may allow for a user to deviate from a desired “blink sequence,” such as a plus or minus one (1) error window, wherein one or more of lens activation, control, and focus change can occur. Additionally, this may allow for variation in the user's timing of the blink sequence.

An exemplary blink sequence may be defined as follows:

1. blink (closed) for 0.5 s

2. open for 0.5 s

3. blink (closed) for 0.5 s

At a one hundred (100) ms sample rate, a twenty (20) sample blink template is given by

blink_template=[1,1,1, 0,0,0,0,0, 1,1,1,1,1, 0,0,0,0,0, 1,1].

The blink mask is defined to mask out the samples just after a transition (0 to mask out or ignore samples), and is given by

blink_mask=[1,1,1, 0,1,1,1,1, 0,1,1,1,1, 0,1,1,1,1, 0,1].

Optionally, a wider transition region may be masked out to allow for more timing uncertainty, and is given by

blink_mask=[1,1,0, 0,1,1,1,0, 0,1,1,1,0, 0,1,1,1,0, 0,1].

Alternate patterns may be implemented, e.g. single long blink, in this case a 1.5 s blink with a 24-sample template, given by blink_template=[1,1,1,1,0,0,0,0,0,0,0,0,0,0,0,0,0,0,0,1,1,1,1,1].

It is important to note that the above example is for illustrative purposes and does not represent a specific set of data.

Detection of a blink pattern may be implemented by logically comparing the history of samples against the template and mask. The blink pattern may be a gesture (e.g., or a part of a gesture), such as a gesture to trigger gesture mode, a gesture during gesture mode, or any other command. The logical operation is to exclusive-OR (XOR) the template and the sample history sequence, on a bitwise basis, and then verify that all unmasked history bits match the template. For example, as illustrated in the blink mask samples above, in each place of the sequence of a blink mask that the value is logic 1, a blink has to match the blink mask template in that place of the sequence. However, in each place of the sequence of a blink mask that the value is logic 0, it is not necessary that a blink matches the blink mask template in that place of the sequence. For example, the following Boolean algorithm equation, as coded in MATLAB®, may be utilized:

matched=not(blink_mask)|not(xor(blink_template,test_sample)),

wherein test_sample is the sample history. The matched value is a sequence with the same length as the blink template, sample history and blink mask. If the matched sequence is all logic 1's, then a good match has occurred. Breaking it down, not (xor (blink template, test_sample)) gives a logic 0 for each mismatch and a logic 1 for each match. Logic with the inverted mask forces each location in the matched sequence to a logic 1 where the mask is a logic 0. Accordingly, the more places in a blink mask template where the value is specified as logic 0, the greater the margin of error in relation to a person's blinks is allowed. MATLAB® is a high level language and implementation for numerical computation, visualization and programming and is a product of MathWorks, Natick, Mass. It is also important to note that the greater the number of logic 0's in the blink mask template, the greater the potential for false positive matched to expected or intended blink patterns. Additionally or alternatively, pseudo code for may be implemented, such as:

match if (mask & (template ̂ history)==0)

where & is a bitwise AND, ̂ is bitwise XOR and ==0 tests whether the value of the result equals zero.

FIG. 14 illustrates, in block diagram form, an exemplary powered ophthalmic lens 1400 comprising a combined blink detection and communication system. The ophthalmic lens 1400 may include a power source 1402, a power management circuit 1404, a photodetector 1406, a signal processing circuit 1408, a system controller 1410 and an actuator 1412. When the ophthalmic lens 1400 is placed onto the front surface of a user's eye the photodetector 1406, the signal processing circuit 1408, and the system controller 1410 may be utilized to detect ambient light, variation in incident light levels, and/or infrared communication signals and may be utilized to control the actuator 1412. Although FIG. 1 illustrates an example of an ophthalmic lens, the components and circuitry described herein may be applied to other and ophthalmic devices, such as wearable lenses, including contact lenses, implantable lenses, including intraocular lenses (IOLs) and any other type of device comprising optical components that incorporate electronic circuits and associated signal paths configured to process one or more inputs received by the ophthalmic device.

The photodetector 1406 may be embedded into the ophthalmic lens 1400. As such, the photodetector 1406 may be configured to receive light such as ambient or infrared light 1401 that is incident to the ophthalmic lens 1400 and/or eye of a wearer of the ophthalmic lens 1400. The photodetector 1406 may be configured to generate and/or transmit a light-based signal 1414 having a value representative of the light energy incident on the ophthalmic lens 1400. As an example, the light-based signal 1414 may be provided to the signal processing circuit 1408 or other processing mechanism. The photodetector 1406 and the signal processing circuit 1408 may define at least a portion of the multifunctional signal path, as described herein. The photodetector 1406 and the signal processing circuit 1408 may be configured for two-way communication. The signal processing circuit 1408 may provide one or more signals to the photodetector 1406, examples of which are set forth subsequently. The signal processing circuit 1408 may include circuits configured to perform analog to digital conversion and digital signal processing, including one or more of filtering, processing, detecting, and otherwise manipulating/processing data to permit incident light detection for downstream use. The signal processing circuit 1408 may provide a data signal 1416 based on the light based signal 1414. As an example, the data signal 1416 may be provided to the system controller 110. The system controller 1410 and the signal processing circuit 1408 may be configured for two-way communication. The system controller 1410 may provide one or more control or data signals to the signal processing circuit 1408, examples of which are set forth subsequently. The system controller 1410 may be configured to detect predetermined sequences of light variation indicative of specific blink patterns or infrared communication protocols. Upon detection of a predetermined sequence the system controller 1410 may act to change the state of actuator 1412, for example, by enabling, disabling or changing an operating parameter such as an amplitude or duty cycle of the actuator 1412.

As an illustrative example, the system controller 1410 may be configured to detect predetermined sequences of light variation indicative of a human-capable pattern or sequence such as a blink pattern. In some embodiments the blink sequence may comprise two low intervals of 0.5 seconds separated by a high interval of 0.5 seconds. A template of length 24 of data values representative of the blink sequence sampled at a 0.1 second or 10 Hz rate is [1, 1, 1, 1, 1, 1, 0, 0, 0, 0, 0, 1, 1, 1, 1, 1, 0, 0, 0, 0, 0, 1, 1, 1].

The system controller 1410 may be configured to detect predetermined sequences of light variation indicative of a non-human-capable pattern or sequence such as a generated infrared communication pattern. In some embodiments the IR sequence may comprise a number of, for example six, alternating high and low intervals of 0.2 seconds each. Such a sequence would be very unlikely to be produced by a human eye lid, and thus represents a unique sequence not produced by blinking. In the present disclosure the special IR sequence indicates that a higher data rate IR communication signal is starting. A template of length 24 of data values representative of the IR sequence sampled at a 0.1 second or 10 Hz rate is [1, 1, 0, 0, 1, 1, 0, 0, 1, 1, 0, 0, 1, 1, 0, 0, 1, 1, 0, 0, 1, 1, 0, 0].

The signal processing circuit 1408 may provide an indication signal to the photodetector 1406 to automatically adjust the gain of the photodetector 1406 in response to ambient or received light levels in order to maximize the dynamic range of the system. The system controller 1410 may provide one or more control signals to the signal processing circuit 1408 to initiate a data conversion operation or to enable or disable automatic gain adjustment of the photodetector 1406 and signal processing circuit 108 in different modes of operation. The system controller 1410 may be configured to periodically enable the photodetector 1406 and the signal processing circuit 108 to periodically sample the light 1401. The system controller 1410 may be further configured to modify the sample rate depending on a mode of operation. For example, a low sample rate may be used for detection of a blink sequence or an IR sequence, and a high sample rate may be used for receiving and decoding an infrared communication signal having a higher data rate or symbol rate than may be accommodated with the low sample rate. For example, a low sample rate of 0.1 s per sample or 10 Hz may be used for detection of the predetermined sequences, and a high sample rate of 390.625 us per sample or 2.56 kHz may be used for sampling of an infrared communication signal having a symbol rate of 3.125 ms per symbol or 320 symbols per second.

Automatic gain control systems as described above may have one or more associated time constants corresponding to the response time of the automatic gain control functions. In order to minimize complexity of the combined blink detection and communication system the automatic gain control system of the signal processing circuit 1408 may be optimized for operation during detection of blink sequences and not for higher data rate communication signals. In this case the system controller 1410 may disable the automatic gain control system and further may direct the signal processing circuit 1408 to hold the gain at a high level when operating with a high sample rate. For example, some embodiments of the powered ophthalmic lens 1400 may support infrared signal detection only in environments with ambient light levels below 5000 lux and with infrared communication signals having incident power greater than 1 watt per square meter. The signal processing circuit 1408 may operate with a gain dependent on the sample rate, an example of which is set forth subsequently. Under this range of conditions it may be possible to provide the data signal 1416 with sufficient signal-to-noise ratio for detection while configuring the photodetector 1406 and signal processing circuit 1408 to have a constant gain from incident light energy to the amplitude or value of the data signal 1416. In this way the system complexity may be minimized compared to a system that may operate with variable gain during infrared communication signal detection or processing.

The signal processing circuit 1408 may be implemented as a system comprising an integrating sampler, an analog to digital converter and a digital logic circuit configured to provide a digital data signal 1416 based on the light based signal 1414. The system controller 1410 also may be implemented as a digital logic circuit and implemented as a separate component or integrated with signal processing circuit 1408. Portions of the signal processing circuit 1408 and system controller 1410 may be implemented in custom logic, reprogrammable logic or one or more microcontrollers as are well known to those of ordinary skill in the art. The signal processing circuit 108 and system controller 1410 may comprise associated memory to maintain a history of values of the light based signal 1414, the data signal 1416 or the state of the system. Any suitable arrangement and/or configuration may be utilized.

A power source 1402 supplies power for numerous components comprising the ophthalmic lens 1400. The power may be supplied from a battery, energy harvester, or other suitable means as is known to one of ordinary skill in the art. Essentially, any type of power source 1402 may be utilized to provide reliable power for all other components of the system. A blink sequence or an infrared communication signal having a predetermined sequence or message value may be utilized to change the state of the system and/or the system controller as set forth above. Furthermore, the system controller 1410 may control other aspects of a powered ophthalmic lens depending on input from the signal processing circuit 1408, for example, changing the focus or refractive power of an electronically controlled lens through the system controller 1410. As illustrated, the power source 1402 is coupled to each of the other components through the power management circuit 1404 and would be connected to any additional element or functional block requiring power. The power management circuit 1404 may comprise electronic circuitry such as switches, voltage regulators or voltage charge pumps to provide voltage or current signals to the functional blocks in the ophthalmic lens 1400. The power management circuit 1404 may be configured to send or receive control signals to or from the system controller 1410. For example, the system controller 1410 may direct the power management circuit 1404 to enable a voltage charge pump to drive the actuator 1412 with a voltage higher than that provided by the power source 1402.

The actuator 1412 may comprise any suitable device for implementing a specific action based upon a received command signal. For example if a blink activation sequence is detected, as described above, the system controller 1410 may enable the actuator 1412 to control a variable-optic element of an electronic or powered lens. The actuator 1412 may comprise an electrical device, a mechanical device, a magnetic device, or any combination thereof. The actuator 1412 receives a signal from the system controller 1410 in addition to power from the power source 1402 and the power management circuit 1404 and produces some action based on the signal from the system controller 1410. For example, if the system controller 1410 detects a signal indicative of the wearer trying to focus on a near object, the actuator 1412 may be utilized to change the refractive power of the electronic ophthalmic lens, for example, via a dynamic multi-liquid optic zone. In an alternate exemplary embodiment, the system controller 1410 may output a signal indicating that a therapeutic agent should be delivered to the eye(s). In this exemplary embodiment, the actuator 1412 may comprise a pump and reservoir, for example, a microelectromechanical system (MEMS) pump. As set forth above, the powered lens of the present disclosure may provide various functionality; accordingly, one or more actuators 1412 may be variously configured to implement the functionality. For example, a variable-focus ophthalmic optic or simply the variable-focus optic may be a liquid lens that changes focal properties, e.g. focal length, in response to an activation voltage applied across two electrical terminals of the variable-focus optic. It is important to note, however, that the variable-focus lens optic may comprise any suitable, controllable optic device such as a light-emitting diode or microelectromechanical system (MEMS) actuator.

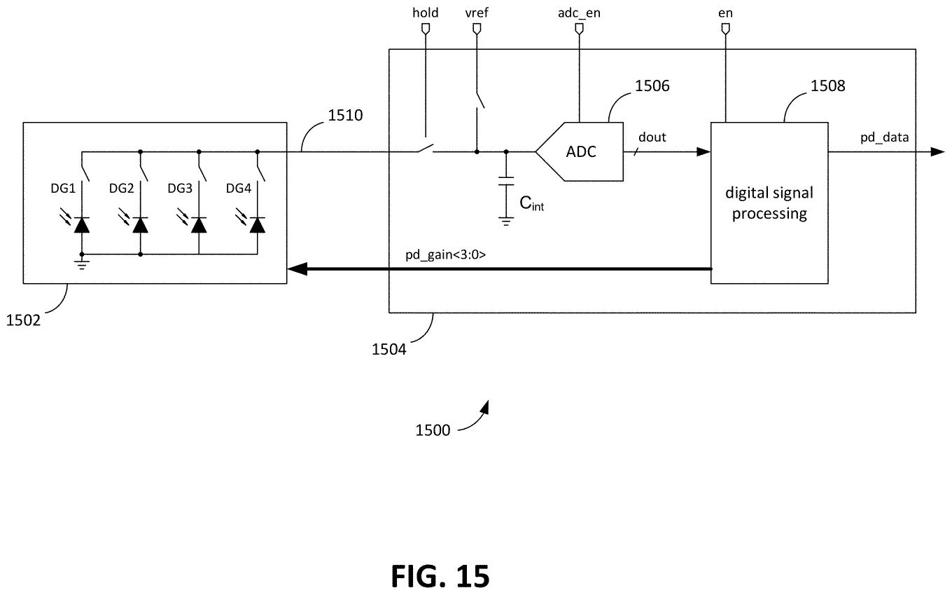

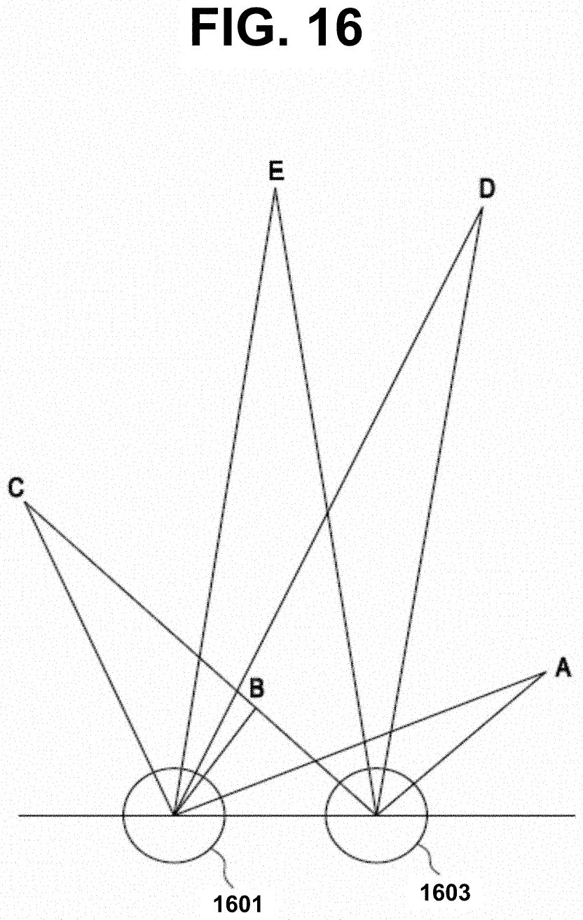

FIG. 15 illustrates, in party schematic and partly block-diagram form, a photodetection system 1500 comprising a photodetector 1502 and a signal processing circuit 1504 in accordance with some embodiments of the present disclosure. The photodetection system 1500 may define at least a portion of the multifunctional signal path, as described herein. The photodetector 1502 may comprise photodiodes DG1, DG2, DG3 and DG4, which are selectively coupled to a cathode node 1510. The signal processing circuit 1504 may comprise an analog to digital converter 1506 and a digital signal processing circuit 1508. The analog to digital converter 1506 may be configured to receive a signal from the photodetector 1502 and to provide a digital converted signal (dout) to the digital signal processing circuit 1508. The digital signal processing circuit 1508 may comprise circuits configured to perform digital signal processing, including one or more of filtering, processing, detecting, and otherwise manipulating/processing data to permit incident light detection for downstream use. The digital signal processing circuit 1508 may be configured to provide a gain setting signal pd_gain to the photodetector 1502, for example to perform the selective coupling of photodiodes DG1, DG2, DG3 and DG4. The digital signal processing circuit 1508 may be further configured to receive control signals to enable or disable switches, circuits or operating modes of circuits within the digital signal processing circuit 1508.

In some embodiments of the present disclosure, signal processing circuit 1504 may further comprise an integration capacitor and switches to selectively couple the cathode node 1510 or a voltage reference to the integration capacitor. The integration capacitor may be configured to integrate a photocurrent developed by the photodetector 1502 and to provide a voltage signal based on the integration time and a magnitude of the photocurrent. The photodetection system 1500 may operate with a periodic sampling rate. During each sample interval the integration capacitor may be first coupled to a voltage reference, such that the integration capacitor is precharged at the start of the sample interval to a predetermined reference voltage, and then may be disconnected from the voltage reference and coupled to the cathode node 1510 to integrate the photocurrent for an integration time corresponding to all or most of the remainder of the sample interval. The magnitude of the voltage signal at the end of the integration time is proportional to the integration time and the magnitude of the photocurrent. Shorter sample intervals corresponding to higher sample rates have lower voltage gain than longer sample intervals and lower sampling rates, where the voltage gain is defined as the ratio of the magnitude of the voltage signal at the end of the integration time to the magnitude of the photocurrent. At high sample rates more photodiodes may be coupled to cathode node 1510 to increase the photocurrent to produce a higher magnitude voltage signal than would be produced with fewer diodes. Similarly, the number of photodiodes coupled to cathode node 1510 may be increased or decreased in response to the magnitude of the photocurrent to ensure the magnitude of the voltage signal is within a useful dynamic range of the analog to digital converter 1506. For example, an incident light energy of 1000 lux may generate a photocurrent of 10 pA in photodiode DG1. At a low sample rate of 0.1 s per sample or 10 Hz the photocurrent may be integrated on integration capacitor Cᵢₙₜ having a value of 5 picofarads (pF) for 0.1 s in turn providing a voltage of 200 mV on the integration capacitor Cᵢₙₜ and provided to the analog to digital converter 1506. However a lower incident light energy of 200 lux will only generate 2 pA and an integrated voltage of 40 mV therefore leading to reduced signal dynamic range at the input to the analog to digital converter 1506. Increasing the number of diodes by a factor of five, for example by coupling photodiode DG2 which may have a area four times that of photodiode DG1 provides a total photocurrent of 10pA restoring the signal level to 200 mV at the input to the analog to digital converter 1506. In a second example, an incident infrared light energy of 1 watt per square meter may generate a photocurrent of 3 pA total in photodiodes DG1 and DG2. At a 0.1 s sample rate and 0.1 s integration time this is sufficient to generate an integrated voltage of 60 mV. At a higher sample rate and shorter integration time of 390.625 ps or 2.56 kHz this photocurrent generates an integrated voltage of only 0.23 uV, which is too low for detection. Coupling photodiodes DG3 and DG4 provides larger total photodiode area and higher photocurrent on the order of 1.6 nA, leading to an integrated voltage of 125 mV, which provides significantly better signal level and dynamic range. The analog to digital converter 1506 may be, for example, of a type that provides eight (8) bits of resolution in a full scale voltage range of 1.8V. For this example analog to digital converter signal levels from 40 mV to 200 mV yield digital output values between 5 and 28 with a maximum value of 255 for a 1.8V input signal. It will be appreciated by those of ordinary skill in the art that the photodiodes DG1, DG2, DG3 and DG4 may be designed to have any desirable scaling or areas for different purposes or system and environmental requirements, such as uniform weighting, binary weighting or other factors such as a factor of four in the preceding example.

It should be appreciated that a variety of expected or intended blink patterns may be programmed into a device with one or more active at a time. More specifically, multiple expected or intended blink patterns may be utilized for the same purpose or functionality, or to implement different or alternate functionality. For example, one blink pattern may be utilized to cause the lens to zoom in or out on an intended object while another blink pattern may be utilized to cause another device, for example, a pump, on the lens to deliver a dose of a therapeutic agent. One blink pattern may be part of a first gesture, while another blink pattern may be all or part of a second gesture. A blank pattern may be used as a punctuation gesture to indicate separation between two separate gestures.

As described herein, various gestures of the eye, eyelid, or external gesture associated with the eye may be detected and used for control of one or more action. Custom gestures may be created by wearers or other sources and may be stored and referenced to control certain actions. Actions associated with gestures may be associated and disassociated to allow control of various actions using the same gesture. Eye gestures may be detected when the eyes are open or closed. Eye gestures may be detected as a result of tracking the eye during other ancillary actions such as following an icon on a screen or other calibration/control techniques.

It is important to note that the above described elements may be realized in hardware, in software or in a combination of hardware and software. In addition, the communication channel may comprise any include various forms of wireless communications. The wireless communication channel may be configured for high frequency electromagnetic signals, low frequency electromagnetic signals, visible light signals, infrared light signals, and ultrasonic modulated signals. The wireless channel may further be used to supply power to the internal embedded power source acting as rechargeable power means.

The present invention may be a system, a method, and/or a computer program product. The computer program product being used by a controller for causing the controller to carry out aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method, comprising:
receiving, by a first sensor system disposed on or in a first ophthalmic device, first sensor data representing a first movement of a user, wherein the first ophthalmic device is disposed adjacent an eye of the user;
determining, based on at least the first sensor data, that the first movement is indicative of a gesture mode trigger;
causing, based on the gesture mode trigger, the first sensor system to enter a gesture mode;
receiving, during the gesture mode, second sensor data;
determining, based on the second sensor data, a second movement, wherein the second movement represents a change relative to one or more of a first axis and a second axis;
determining a gesture of the user by comparing the second movement to one or more stored movements associated with corresponding gestures; and
processing the gesture of the user.

2. The method of claim 1, wherein the first movement comprises closing an eyelid of the eye or moving the eye beyond a threshold angle.

3. The method of claim 1, wherein the first movement comprises closing an eyelid of the eye and performing the second movement while the eyelid remains closed.

4. The method of claim 1, wherein the first movement comprises moving the eye beyond a threshold angle for a threshold time and performing the second movement after performing the first movement.

5. The method of claim 1, wherein determining, based on at least the first sensor data, that the first movement is indicative of the gesture mode trigger comprises determining one or more of a length of time of the first movement, a complexity of the first movement, an intensity of the first movement, or a severity of an angle of movement of the eye.

6. The method of claim 1, further comprising:
receiving, during the gesture mode, third sensor data; and
determining, based on the third sensor data, an additional gesture of the user, wherein the gesture and the additional gesture are distinguished as two gestures based on a punctuation gesture configured to indicate a separation in gestures.

7. The method of claim 1, wherein the second movement comprises one or more of: a circular movement around one or more of the first axis and the second axis, or a circular movement at a fixed distance around a reference point of one or more of the first axis or the second axis.

8. The method of claim 1, wherein the second movement comprises one or more of: a linear movement along one or more of the first axis and the second axis, or a linear movement at a fixed angle from one or more of the first axis or the second axis.

9. The method of claim 1, wherein change relative to one or more of the first axis and the second axis comprises one or more of a change in yaw and a change of pitch.

10. The method of claim 1, wherein the first sensor system comprises a first accelerometer configured to measure acceleration along an x-axis, a second accelerometer configured to measure acceleration along a y-axis perpendicular to the x-axis, and a third accelerometer configured to measure acceleration along a z-axis perpendicular to the x-axis and the y-axis, further comprising mapping data of the first accelerometer, the second accelerometer, and the third accelerometer to one or more of the first axis or the second axis.

11. The method of claim 1, wherein the gesture relates to an accommodation threshold, and wherein processing the gesture comprises changing the accommodation threshold.

12. The method of claim 1, wherein the gesture relates to an operational mode, and wherein processing the gesture comprises changing the operational mode.

13. The method of claim 1, wherein the first sensor data is received during a calibration sequence.

14. The method of claim 1, wherein the first sensor data is received during a power conservation mode in which one or more sensors receive limited power or no power.

15. The method of claim 1, wherein determining the gesture of the user by comparing the second movement to one or more stored movements associated with corresponding gestures comprises determining the gesture of the user by comparing a change in one or more of yaw and pitch of the second movement to changes in one or more of yaw and pitch of the stored movements associated with the corresponding gestures.

16. The method of claim 1, wherein determining the gesture of the user by comparing the second movement to one or more stored movements associated with corresponding gestures comprises determining the gesture of the user by comparing a degree of the change to one or more degrees of changes of the stored movements associated with the corresponding gestures.

17. The method of claim 1, wherein determining the gesture of the user by comparing the second movement to one or more stored movements associated with corresponding gestures comprises determining the gesture of the user by comparing a direction of the second movement to one or more directions of the stored movements associated with the corresponding gestures.

18. The method of claim 1, wherein determining the gesture of the user by comparing the second movement to one or more stored movements associated with corresponding gestures comprises determining the gesture of the user by comparing an intensity of the second movement to one or more intensities of the stored movements associated with the corresponding gestures.

19. An ophthalmic system comprising:
a first ophthalmic device configured to be disposed adjacent a first eye of a user, the first ophthalmic device comprising a first sensor system, the first sensor system comprising a first sensor and a first processor operably connected to the first sensor; and
a second ophthalmic device configured to be disposed adjacent a second eye of the user, the second ophthalmic device comprising a second sensor system, the second sensor system comprising a second sensor and a second processor operably connected to the second sensor,
wherein one or more of the first processor or the second processor is configured to,
receive, from one or more of the first sensor or the second sensor, first sensor data representing a first movement of a user;
determine, based on at least the first sensor data, that the first movement is indicative of a gesture mode trigger;
cause, based on the gesture mode trigger, the first sensor system to enter a gesture mode;
receive, during the gesture mode, second sensor data;
determine, based on the second sensor data, a second movement, wherein the second movement represents a change relative to one or more of a first axis and a second axis;
determine a gesture of the user by comparing the second movement to one or more stored movements associated with corresponding gestures; and
process the gesture of the user.

20. The ophthalmic system of claim 19, wherein the first movement comprises closing an eyelid of the eye or moving the eye beyond a threshold angle.

21. The ophthalmic system of claim 19, wherein the first movement comprises closing an eyelid of the eye and performing the second movement while the eyelid remains closed.

22. The ophthalmic system of claim 19, wherein the first movement comprises moving the eye beyond a threshold angle for a threshold time and performing the second movement after performing the first movement.

23. The ophthalmic system of claim 19, wherein one or more of the first processor or the second processor being configured to determine, based on at least the first sensor data, that the first movement is indicative of the gesture mode trigger comprises one or more of the first processor or the second processor being configured to determine one or more of a length of time of the first movement, a complexity of the first movement, an intensity of the first movement, or a severity of an angle of movement of the eye.

24. The ophthalmic system of claim 19, wherein one or more of the first processor or the second processor is further configured to:
receive, during the gesture mode, third sensor data; and
determine, based on the third sensor data, an additional gesture of the user, wherein the gesture and the additional gesture are distinguished as two gestures based on a punctuation gesture configured to indicate a separation in gestures.

25. The ophthalmic system of claim 19, wherein the second movement comprises one or more of: a circular movement around one or more of the first axis and the second axis, or a circular movement at a fixed distance around a reference point of one or more of the first axis or the second axis.

26. The ophthalmic system of claim 19, wherein the second movement comprises one or more of: a linear movement along one or more of the first axis and the second axis, or a linear movement at a fixed angle from one or more of the first axis or the second axis.

27. The ophthalmic system of claim 19, wherein the change relative to one or more of a first axis and a second axis comprises one or more of a change in yaw and change of pitch.

28. The ophthalmic system of claim 19, wherein the first sensor system comprises a first accelerometer configured to measure acceleration along an x-axis, a second accelerometer configured to measure acceleration along a y-axis perpendicular to the x-axis, and a third accelerometer configured to measure acceleration along a z-axis perpendicular to the x-axis and the y-axis, further comprising mapping data of the first accelerometer, the second accelerometer, and the third accelerometer to one or more of the first axis or the second axis.

29. The ophthalmic system of claim 19, wherein the gesture relates to an accommodation threshold, and wherein processing the gesture comprises changing the accommodation threshold.

30. The ophthalmic system of claim 19, wherein the gesture relates to an operational mode, and wherein processing the gesture comprises changing the operational mode.

31. The ophthalmic system of claim 19, wherein the first sensor data is received during a calibration sequence.

32. The ophthalmic system of claim 19, wherein the first sensor data is received during a power conservation mode in which one or more of the first sensor and the second sensor receive limited power or no power.

33. The ophthalmic system of claim 19, wherein determining the gesture of the user by comparing the second movement to one or more stored movements associated with corresponding gestures comprises determining the gesture of the user by comparing a change in one or more of yaw and pitch of the second movement to one or more changes in one or more of the yaw and the pitch of the stored movements associated with the corresponding gestures.

34. The ophthalmic system of claim 19, wherein determining the gesture of the user by comparing the second movement to one or more stored movements associated with corresponding gestures comprises determining the gesture of the user by comparing a degree in the change of the second movement to one or more degrees of change of the stored movements associated with the corresponding gestures.

35. The ophthalmic system of claim 19, wherein determining the gesture of the user by comparing the second movement to one or more stored movements associated with corresponding gestures comprises determining the gesture of the user by comparing a direction of the second movement to one or more directions of the stored movements associated with the corresponding gestures.

36. The ophthalmic system of claim 19, wherein determining the gesture of the user by comparing the second movement to one or more stored movements associated with corresponding gestures comprises determining the gesture of the user by comparing an intensity of the change of the second movement to one or more intensities of change of the stored movements associated with the corresponding gestures.

37. An ophthalmic system comprising:
a first ophthalmic device configured to be disposed adjacent at least one of a right eye of a user or a left eye of the user; and
a first sensor system disposed in or on the first ophthalmic device, the first sensor system comprising a first sensor and a first processor operably connected to the first sensor and configured to cause pairing of the first sensor system and a second sensor system disposed in or on a second ophthalmic device,
wherein the first processor is configured to:
receive, from the first sensor, first sensor data representing a first movement of a user;
determine, based on at least the first sensor data, that the first movement is indicative of a gesture mode trigger;
cause, based on the gesture mode trigger, the first sensor system to enter a gesture mode;
receive, during the gesture mode, second sensor data;
determine, based on the second sensor data, a second movement, wherein the second movement represents a change relative to one or more of a first axis and a second axis;
determine a gesture of the user by comparing the second movement to one or more stored movements associated with corresponding gestures; and
process the gesture of the user.

38. The ophthalmic system of claim 37, wherein the first movement comprises closing an eyelid of the eye or moving the eye beyond a threshold angle.

39. The ophthalmic system of claim 37, wherein the first movement comprises closing an eyelid of the eye and performing the second movement while the eyelid remains closed.

40. The ophthalmic system of claim 37, wherein the first movement comprises moving the eye beyond a threshold angle for a threshold time and performing the second movement after performing the first movement.

41. The ophthalmic system of claim 37, wherein the first processor or the second processor being configured to determine, based on at least the first sensor data, that the first movement is indicative of the gesture mode trigger comprises the first processor being configured to determine one or more of a length of time of the first movement, a complexity of the first movement, an intensity of the first movement, or a severity of an angle of movement of the eye.

42. The ophthalmic system of claim 37, wherein the first processor is further configured to:
receive, during the gesture mode, third sensor data; and
determine, based on the third sensor data, an additional gesture of the user, wherein the gesture and the additional gesture are distinguished as two gestures based on a punctuation gesture configured to indicate a separation in gestures.

43. The ophthalmic system of claim 37, wherein the second movement comprises one or more of: a circular movement around one or more of the first axis and the second axis, or a circular movement at a fixed distance around a reference point of one or more of the first axis or the second axis.

44. The ophthalmic system of claim 37, wherein the second movement comprises one or more of: a linear movement along one or more of the first axis and the second axis, or a linear movement at a fixed angle from one or more of the first axis or the second axis.

45. The ophthalmic system of claim 37, wherein the change relative to one or more of the first axis and the second axis comprises one or more of a change in yaw or a change of pitch.

46. The ophthalmic system of claim 37, wherein the first sensor system comprises a first accelerometer configured to measure acceleration along an x-axis, a second accelerometer configured to measure acceleration along a y-axis perpendicular to the x-axis, and a third accelerometer configured to measure acceleration along a z-axis perpendicular to the x-axis and the y-axis, further comprising mapping data of the first accelerometer, the second accelerometer, and the third accelerometer to one or more of the first axis or the second axis.

47. The ophthalmic system of claim 37, wherein the gesture relates to an accommodation threshold, and wherein processing the gesture comprises changing the accommodation threshold.

48. The ophthalmic system of claim 37, wherein the gesture relates to an operational mode, and wherein processing the gesture comprises changing the operational mode.

49. The ophthalmic system of claim 37, wherein the first sensor data is received during a calibration sequence.

50. The ophthalmic system of claim 37, wherein the first sensor data is received during a power conservation mode in which the first sensor receives limited power or no power.

51. The ophthalmic system of claim 37, wherein determining the gesture of the user by comparing the second movement to one or more stored movements associated with corresponding gestures comprises determining the gesture of the user by comparing a change in one or more of yaw and pitch of the second movement to one or more changes in one or more of the yaw and the pitch of the stored movements associated with the corresponding gestures.

52. The ophthalmic system of claim 37, wherein determining the gesture of the user by comparing the second movement to one or more stored movements associated with corresponding gestures comprises determining the gesture of the user by comparing a degree in the change of the second movement to one or more degrees of change of the stored movements associated with the corresponding gestures.

53. The ophthalmic system of claim 37, wherein determining the gesture of the user by comparing the second movement to one or more stored movements associated with corresponding gestures comprises determining the gesture of the user by comparing a direction of the second movement to one or more directions of the stored movements associated with the corresponding gestures.

54. The ophthalmic system of claim 37, wherein determining the gesture of the user by comparing the second movement to one or more stored movements associated with corresponding gestures comprises determining the gesture of the user by comparing an intensity of the change of the second movement to one or more intensities of change of the stored movements associated with the corresponding gestures.

55. A method, comprising:
receiving, by a sensor system disposed on or in an ophthalmic device, sensor data representing a movement of a user, wherein the ophthalmic device is disposed adjacent an eye of the user, wherein the movement represents a change relative to one or more of a first axis and a second axis;
determining, based at least on the sensor data, a gesture of the user by comparing the movement to one or more stored movements associated with corresponding gestures; and
processing the gesture of the user to cause transmission of an output.

56. The method of claim 55, wherein the movement comprises closing an eyelid of the eye or moving the eye beyond a threshold angle.

57. The method of claim 55, wherein determining the gesture comprises determining one or more of a length of time of the movement, a complexity of the movement, an intensity of the movement, or a severity of an angle of movement of the eye, or a combination thereof.

58. An ophthalmic system comprising:
a first ophthalmic device configured to be disposed adjacent at least one of a right eye of a user or a left eye of the user; and
a first sensor system disposed in or on the first ophthalmic device, the first sensor system comprising a first sensor and a first processor operably connected to the first sensor and configured to cause pairing of the first sensor system and a second sensor system disposed in or on a second ophthalmic device,
wherein the first processor is configured to:
receive sensor data representing a movement of a user, wherein the movement represents a change relative to one or more of a first axis and a second axis;
determine, based at least on the sensor data, a gesture of the user by comparing the movement to one or more stored movements associated with corresponding gestures; and
process the gesture of the user to cause transmission of an output.

59. The ophthalmic system of claim 58, wherein the movement comprises closing an eyelid of the eye or moving the eye beyond a threshold angle.

60. The ophthalmic system of claim 58, wherein determining the gesture comprises determining one or more of a length of time of the movement, a complexity of the movement, an intensity of the movement, or a severity of an angle of movement of the eye, or a combination thereof.
